(19) United States
(12) Patent Application Publication
(10) Pub. No.: US 2004/0225880 A1
(43) Pub. Date: Nov. 11, 2004

(54) Strong authentication systems built on combinations of "what user knows" authentication factors

(75) Inventor: Len L. Mizrah, San Carlos, CA (US)

Correspondence Address: HAYNES BEFFEL & WOLFELD LLP, P O BOX 366, HALF MOON BAY, CA, 94019, US

(73) Assignee: AUTHENTURE, INC., Walnut Creek, CA

(21) Appl. No.: 10/431,396

(22) Filed: May 7, 2003

(51) Int. Cl. H04L 9/00

(52) U.S. Cl. 713/155

(57) ABSTRACT

A system for authentication of a client includes logic supporting combinations of more than one a “what user knows” authentication factors for strong authentication of a client, such as a static password, random partial pattern recognition factor and a random partial digitized path recognition factor. An interactive method for authentication of a client in a network environment utilizes two or more “what user knows” authentication factors. The two or more “what user knows” authentication factors are algorithmically and parametrically independent. The client is prompted to provide a server the first “what user knows” authentication factor over a communication medium. The server verifies the first “what user knows” authentication factor. If successful, then the client is prompted to provide the server the second “what user knows” authentication factor. The server verifies the second “what user knows” authentication factor, and so on, to complete the authentication process.

### RELATED APPLICATION DATA

The present application is related to my prior U.S. patent application Ser. No. 10/328,640, filed 23 Dec. 2002, entitled “Authentication System and Method Based upon Random Partial Pattern Recognition”; U.S. patent application Ser. No. 10/353,500; filed 29 Jan. 2003, entitled “System and Method for User Authentication Interface”; and U.S. patent application Ser. No. 10/378,226 filed 3 Mar. 2003, entitled “Operation Modes for User Authentication System Based on Random Partial Pattern Recognition”. The present application is also related to my U.S. patent application No. xx/xxx,xxx, filed on the same day as the present application, entitled “Authentication System and Method Based upon Random Partial Digital Path Recognition,” which is incorporated by reference as if fully set forth herein.

### BACKGROUND OF THE INVENTION

1. Field of the Invention

The invention relates generally to user authentication systems, used for computer and network security access control systems; and more particularly “strong” authentication algorithms and systems based on more than one authentication factor, including “what user knows”-based authentication factors, in client/server network architectures and other architectures.

2. Description of Related Art

The most widely used user authentication method is referred to herein as the Standard Static Password Recognition (SSPR) algorithm. The SSPR algorithm simply requires a user to enter a user name and a password for authentication. This is a “what user knows” type authentication factor. Other types of authentication factors are not as widely deployed, and include “what user has” (card key), and “what user is” (fingerprint). “What user has” and “what user is” type authentication factors require special hardware devices, such as card readers, tokens, fingerprint sensors and the like at the input terminals, and therefore are typically much more expensive and impractical than a “what user knows” type. “What user knows” type authentication factors are limited by the ability of a person to remember the factor involved. For example, typical users select passwords for SSPR within a “comfort level” of complexity for memorization, usually in the range from one to seven (or eight) alphanumeric characters long. Often, the password is a simple word or an integer number (like, “patriot”, “London”, 11223344, etc.). Technological progress and demands of contemporary industrial society security lead to at least two serious issues related to the safety of typical passwords in SSPR, including:

1. An intruder may employ a brute-force technique, known as a dictionary attack, of successively trying all the words in an exhaustive list against a password file. Each consecutive tried word gets encrypted using the same algorithm that the login program under attack is using. Dictionary attacks, applied either to hashed passwords, intercepted on communication lines, or directly at the password entry devices, allow for quite easy password re-engineering.

2. Another issue is related to password combinatorial capacities of typical passwords that are within a “comfort level” of complexity for most users. For larger organizations, a range of passwords within such comfort level may not be sufficient.

Typical enterprise level solutions (enterprise-wide IT department policies) in accounting for items 1 and 2 above, require users to have at least 4-5 (or more) alphanumeric case sensitive character passwords, which should not to be simple words (but rather something, like: 1patRIOT, Lon7Don, etc.). This approach leads to multiple password resets by users that forget or lose their passwords, which resets have become quite costly and annoying hurdles for organizations and enterprises (or service companies) striving for higher security levels.

Objective consideration shows that the minimum number of characters in a password is limited at a minimum by two factors: necessary combinatorial capacities and high susceptibility to combinatorial attacks. The maximum number of characters in static passwords is limited by users' “comfort level” for memorization. Eventually, one ends up with 4-8 alphanumeric characters range (no character case sensitivity), or 3-7 alphanumeric characters (having character case sensitivity). Until recently, organizations and enterprises (or service companies) have tolerated these well known deficiencies due to relative simplicity, low cost, and wide spread adoption of SSPR user authentication technology.

Meanwhile, emerging requirements are forcing the security industry (Authentication-Authorization-Accounting (AAA or 3A) programs, Encryption, Enterprise Software, Financial Service Providers, etc.) to re-consider SSPR based user authentication technology:

1. The first issue is progress in ASIC chip data-processing power, which makes combinatorial attacks in breaking static passwords much more efficient. The apparent line of defense would be increasing static password lengths. Unfortunately, as we already discussed, this capability is already quite limited by users' “comfort level”. So, SSPR based security systems appeared to be in between a rock and a hard place, as the minimum password length (3-4 alphanumeric characters) must be increased to sustain more and more efficient combinatorial attacks, whereas the entire static password length has to be remained unchanged and limited to 6-7 alphanumeric characters range due to human being memory limitations.

2. Also, a number of security problems arising in large scale systems, like deficiencies in state/country voting systems, credit card fraud, privacy and security breaches at health data banks and at financial service organizations, Microsoft 2000 and XP operating systems' vulnerabilities, etc., have led to the necessity to improve or re-build large scale security systems. Evolution of these systems will eventually require much higher static password combinatorial capacity, than may be required at an organization/enterprise level. Assuming, about 10 million users at a state level and about 100 million users nation wide, passwords having at least 5 characters are needed for a state-wide system, and passwords having at least 6 characters are needed for country wide password based security systems (assuming no character case sensitivity, or 4 and 5 characters respectively for a character sensitive case). As processing power in the hands of hacker increases, the minimum password size for a secure system approaches or exceeds the “comfort level”.

3. Once national security systems, databases and various markets get integrated internationally (say US and EU), the number of users requiring unique passwords increases to the point that the combinatorial capacity of such systems would require at least 6 alphanumeric characters (case sensitive passwords), or 7 for systems without character case sensitivity. This is already at the boundary of users' “comfort level”.

Accordingly, SSPR is reaching the limits of its practical application for large-scale static password based security systems. That accounts for serious attention recently given to alternative high security user authentication methods, like biometrics, tokens, and smart cards. Of these techniques, biometrics is the only true user authentication method. The other ones can be a part of user authentication systems, but are insufficient by themselves.

Unfortunately, biometrics is great deal more expensive and difficult to deploy, than SSPR based systems. There is, also, a significant public reluctance against biometric authentication methods due to religious and cultural concerns. Another strong concern, if using biometrics, is private biometrics data safety. Once stolen, the biometric data can be re-used forever to impersonate the individual that the data is taken from.

B. Attacks Against SSPR Based Systems

Besides several issues listed above, static password technology is particularly vulnerable to a number of attacks, and defenses against such attacks have limited scope. Some of the possible attacks and defenses to the attacks, include the following:

1. Password Guessing

An intruder tries to log in with a real user name while making password guesses based on the user personal knowledge.

Defense—automatic session lock out after several failed attempts; possible account revoke or a forced password reset

2. Log-In Session Videotaping

Widely available micro audio and visual sensors, and other tools, facilitate hidden observations. Video- and/or audio-recording is possible from a significant distance and any time of the day, jeopardizing secret passwords or PINs entered by computer or network online users at public locations (ATM machines; customers at Point-of-Sales; Internet terminals offered at various conferences, cafes, libraries; employees sharing large offices with desktop computer terminals within everybody's visual reach, and other places).

Defense—no standard protection technology except being vigilant.

3. Shoulder Surfing

An intruder nearby the legitimate user watches password entering.

Defense—no standard protection technology except displaying echo dummy characters and different number of them.

4. Social Engineering

An intruder pretends to be an administrator or a real user asking for a password disclosure/reset.

Defense—non disclosure/reset policy.

5. Trojan Horse

Hidden downloaded software looking like a standard login session but collecting instead user names and passwords.

Defense—some protection is possible for vigilant users and administrators with antivirus protection and intrusion detection software.

6. Keystroke Monitoring

Secretly downloaded software keeping a log of all keystrokes

Defense—employees are defenseless, if the employer is the attack originator; legal protection is a possible alternative.

7. Con Artists

Can figure out the password while being quite far from the real user and having special hearing/observation skills/training.

Defense—no standard protection technology except being vigilant.

8. Network Sniffing

An intruder records user names and passwords while in transit on communication lines.

Defense—encryption protocols: Kerberos, SSL, IPsec; challenge response, one time passwords with tokens or smart cards; biometrics instead of passwords.

9. Keyboard Buffer Memory Sniffing

Some desktop operating systems do not have hardware protection against intruders' software copying passwords from a keyboard buffer.

Defense—no standard protection except making hardware protection at a microprocessor level.

10. Password File Theft

Every user name has a password entry in a hashed form which can be read.

Defense—Needham-Guy algorithm is used: each password is an encryption key for itself to be hash encrypted.

All attacks above can be separated out into three different categories: communication line attacks (8, dictionary attack), attacks at input/output devices (1, 2, 3, 4, 5, 6, 7, 9), and database attacks (10).

C. Enhanced Security Requirements

As manifested by the list of attacks above, SSPR security technology is vulnerable to well known security breaches. SSPR is based on “what user knows”, as opposed to other authentication factors based on “what user has” (for instance, hardware tokens), or “what user is” (such as biometric traits, like, fingerprints, face, eye, and voice recognition). It is well known, “what user knows”-based authentication systems are the most attractive due to being cheap, user friendly, easily electronically deployable, and requiring no additional hardware, as opposed to other authentication factors. That is why numerous attempts have been made to improve SSPR technology and satisfy the requirements of the Internet mass transaction and e-commerce community. Several enhanced user authentication security requirements include the following:

1. Even without encryption, authentication secrets (like passwords or PINs) shared between a client and a server should not be revealed, if the data are intercepted by an intruder, while in transit on communication lines.

2. Authentication system is to demonstrate strong resilience against attacks at input/output devices (see, for example, B1-B7, B9).

3. “What user knows”-based authentication system should use secret knowledge shared with a server, which is easier than, or of comparable difficulty for a human being to remember as compared to static passwords. Otherwise, the system does not have a chance to be widely adopted.

4. Client and server have to perform mutual authentication to each other.

5. Client should be able to get authenticated to by server and get access to protected resources from any computer platform on the Internet.

6. Authentication system should have zero footprint downloaded software on the client computer platform.

7. No additional hardware as compared to SSPR technology.

8. Easy and cheap match to any other authentication factor in building “strong authentication” security systems (having two or more authentication factors).

9. Compatible with security of message-oriented Web Services technologies (like SOAP, SAML, XML, WSDL, etc.).

Representative prior art authentication technologies are described in Juels, US 2002/0029341; Boroditsky, U.S. Pat. No. 6,327,659; Boroditsky, U.S. Pat. No. 6,332,192; Azuma, US 2001/0039618; Jalili, U.S. Pat. No. 6,209,104; Ozzie, U.S. Pat. No. 5,664,099; Davies, U.S. Pat. No. 5,608,387; Blonder, U.S. Pat. No. 5,559,961; Baker, U.S. Pat. No. 5,428,084; Cottrell, U.S. Pat. No. 5,465,084; and Martino U.S. Pat. No 5,276,314.

Many approaches promise certain improvements toward meeting some of the requirements (1-9) listed above. However, no known approach (except SSPR) has experienced wide public and industry acceptance. Further, none allow for a comprehensively secure system and method of user authentication, covering the entire list of requirements listed above. Thus, what is needed is an authentication system and method allowing for highly elevated practical security against most of known attacks on communication lines and at data entry devices while assuring sufficient enough combinatorial capacity. In addition, user interfaces for such new authentication systems which contribute to ease of use and security are required.

D. Strong Authentication Access Control Security Systems

Enhanced security requirements have led to “strong” authentication access control security systems relying on two or more authentication factors, including for example an SSPR authentication factor, and at least one “what user has” or “who user is” type authentication factors. The prime motivation was to compensate for vulnerability of each single authentication factor. The simple idea behind the scene is that it is more difficult to break two or more authentication factors than just one. Examples of well known combinations of authentication factors include: a PIN and a smart card, a password and one of chosen set of biometric factors, a PIN and hardware token. Typically the added security of strong authentication is measured against factors such as cost, the possibility for electronic deployment, ease of use and other factors. “What user has” authentication factors (smart cards, hardware token) and “what user is” authentication factors (biometric traits and hardware devices to recognize them) are generally more expensive, more difficult to use and not easily electronically deployable as compared to SSPR technology. Therefore, there is a substantial need to create new “what user knows” authentication factors (algorithms) which could be as cheap, user friendly and easily electronically deployable as SSPR technology, but at the same time as secure as hardware based authentication factors. Furthermore, it is desirable to provide strong authentication systems based on combinations of “what user knows” type authentication factors.

Representative prior art “strong” authentication technologies are described in Brennan, U.S. Pub. No. 2003/0046551; Angelo, U.S. Pat. No. 6,400,823; Tan et al., U.S. Pub. No. 2001/0045451; Murphy et al., U.S. Pat. No. 6,226,744; Perlman et al., U.S. Pat. No. 6,173,400.

### SUMMARY OF THE INVENTION

The present invention provides strong authentication built on combinations of “what user knows” authentication factors, including unique authentication factors and supporting algorithms for use in a strong authentication environment. The present invention is embodied by an interactive method for strong authentication of a client suitable for deployment in client/server network architectures, and other network architectures.

One embodiment of the invention provides an interactive method for authentication of a client in a network environment which utilizes first and second “what user knows” authentication factors. The first and second “what user knows” authentication factors are algorithmically and parametrically independent. According to this embodiment, the client is first prompted to provide a server the first “what user knows” authentication factor over a communication medium. The server verifies the first “what user knows” authentication factor. If successful, then after verifying the first “what user knows” authentication factor, the client is prompted to provide the server the second “what user knows” authentication factor. The server verifies the second “what user knows” authentication factor to complete the authentication process. Of course, the prompting and verifying for first and second “what user knows” authentication factors should be executed in series—the second authentication factor appears (being prompted and verified) only under condition of a successful user authentication with the first authentication factor. Upon completion of the authentication process, the client is allowed access to protected network resources, for example, or a signal is generated indicating the successful authentication.

In some embodiments, the authentication factors are algorithmically independent because the interactive algorithms executed to satisfy the factors are different. Thus, two standard static password authentication factors, if employed in known manners, are not algorithmically independent. In some embodiments, the authentication factors are parametrically independent because the parameters (i.e. contents of data sets input to satisfy the factors) are not required to be related by any particular function for producing the parameters.

Unique authentication factors suitable for use according to the present invention include random partial pattern recognition RPPR and random partial digitized path recognition RPDPR, which are explained below. RPPR and RPDPR are algorithmically independent of each other, and of standard static password recognition SSPR, because the interactive algorithms used for prompting and verifying are dissimilar.

The RPPR and RPDPR authentication technologies have the positive features of SSPR based security systems, but at the same time, are much stronger in terms of security. RPPR and RPDPR technologies are extremely effective against computer data processing dictionary or brute force attacks, password guessing, password file theft, shoulder surfing, eavesdropping, videotaping, Trojan Horse attack, memory sniffing attacks, keystroke monitoring, and network sniffing. At the same time, RPPR and RPDPR provide “what user knows” authentication methods with enormous combinatorial capacity, while remaining within a user's “comfort level” for memorization suitable for deployment together, in combination with SSPR or with other “what user knows” based authentication factors.

According to various embodiments of the invention, one of the first and second “what user knows” authentication factors comprises static password recognition, and another of the first and second “what user knows” authentication factors is based on random partial pattern recognition. In yet another embodiment, the other of the first and second “what user knows” authentication factors is based on random partial digitized path recognition. In another embodiment, the first and second “what user knows” authentication factors comprise random partial pattern recognition and random partial digitized path recognition. In another embodiment, the process involves three authentication factors, including for example static password recognition, random partial pattern recognition and random partial digitized path recognition.

According to embodiments of the method, a data set of data fields is stored in secure memory. The data fields in the data set have positions in the data set, and include respective field contents, so that the data set specifies a full pattern. The server provides a user interface to the client via a communication medium including a clue, such as positions in the data set of a random subset of data fields from the data set, which identify a random partial pattern derived from the full pattern. For the purpose of clarity, the term “random” as used herein is meant to include pseudo-random.

For a particular authentication factor based on a random partial subset, such as RPPR or RPDPR, the method includes storing a data set in a memory, where data fields in the data set have respective positions in the data set and respective field contents so that the data set includes a full pattern used as a shared secret between a client and a server. The respective field contents for data fields in the data set include a pattern of data known to the client based on a function of the respective positions in the data set. For RPPR, a full pattern is based on the position in the data set, which position is used to determine a parameter that is a function of the position. For RPDPR, a full pattern is based on the position in the data set, which position corresponds to a point on a directed digitized path including a full set of such points, each point characterized by having coordinates on a frame of reference. The position therefore indicates such coordinates to the client, and selecting random indicators of a field, the coordinates can be supplied as a part the authentication factor that corresponds to the position indicated by the clue.

The present invention is embodied by an interactive method for authentication of a client and a user interface for the method. The method is interactive in the sense that the server directs the client via a user interface driven by the server over a communication network through the multiple factor authentication procedure. The prompting includes for example, the server providing a clue to the client, and an input construct by which the client enters a pattern suggested by the clue. For SSPR, the server prompts the user to enter a password, and provides an input construct for accepting the password as input.

The server presents an input construct, as part of a graphical user interface for example which displays the clue. Input construct facilitates input of data corresponding to the field contents of the positions indicated by the clue. For example, the input construct in one embodiment includes an instance of a representation of the frame of reference. The instance of the representation of the frame of reference includes a randomized array of indicators occupying the same positions as data fields having the same coordinates in the frame of reference. The input construct includes input fields for inserting indicators from the randomized array of indicators. The client satisfies the authentication factor by inserting indicators from the coordinates identified by the field contents of data fields having the positions in the data set specified by the clue. The server generates different instances of the frame of reference, in which the randomized array of indicators is changed for different authentication sessions. Thus, a particular indicator corresponds to the field contents that identify particular combination of coordinates, only during a single authentication session.

Embodiments of the invention include an initial step of a detecting an attempted access to protected resources in the data network. In response to detection of the attempted access, the strong authentication procedure is initiated. After successfully completing the strong authentication procedure relying on more than one “what user knows” authentication factors, authentication of the client is signaled, allowing access to a protected resource.

Further embodiments of the invention display an icon during at least one of the first and second prompting and verifying steps. The icon has a first state during the prompting, a second state while waiting for verification, and a third state after verification. For example, in one embodiment the icon comprises a stoplight icon which displays a red light during said prompting, a yellow light while waiting for verification, and a green light after verification. For some embodiments of the strong authentication procedure of the present invention, a first stoplight icon proceeds through the three states during steps corresponding to the first authentication factor, and a second stoplight icon proceeds through the three states during steps corresponding to the second authentication factor. In yet another embodiment, a third stoplight icon is utilized indicating progress for the overall strong authentication procedure.

Embodiments of the invention include a system for authentication of a client. The system includes a data processor including an interface to a database, an interface to a data network, and authentication system programs executable by the data processor. The system programs include authentication logic supporting first and second “what user knows” authentication factors for authentication of a client based upon client credentials including an account user name and parametrically independent account authentication codes which comprise for example the data sets described above.

The input construct may comprise a graphical user interface presented using an Internet browser or a thin client software.

In various embodiments, the field contents of data fields in the data set are based on a cognitive function of position of the data field in the data set. Also in some embodiments, the input construct enables the client to supply field contents for the data fields in the ordered set including alphanumeric characters, images and colors.

The invention is also embodied by authentication systems based on the client/server architecture, and other architectures. In one embodiment, the process is extended to an authentication server for a large number of users. In this embodiment, the process involves maintaining a secure database of user accounts, including data sets of data fields as described above. In this system, attempts to access a protected network resource are detected or otherwise redirected to the server. The server then conducts an authentication session as described above to enable a client to have access to the protected resource.

Systems embodying the present invention include data processing resources including a processor, memory and network interfaces. Authentication server software being executed in the data processing resources carry out the processes for account set up and client authentication, as described above.

The strong authentication procedures using combinations of SSPR, RPDPR and RPPR based authentication technology are as user friendly, as cost effective and as electronically deployable as standard static password technology. At the same time, security is much higher than using a single authentication factor.

Other aspects and advantages of the present invention can be seen on review of the drawings, the detailed description and the claims, which follow.

### BRIEF DESCRIPTION OF THE DRAWINGS

FIG. 1 illustrates client/server architecture for implementation of a user authentication process based on RPPR algorithm according to the present invention.

FIG. 2 is a flowchart of a basic random partial pattern recognition RPPR authentication session according to the present invention.

FIG. 3 illustrates a graphical user interface supporting a log-in process at the user name entry state used in one example of an authentication program according to the present invention.

FIG. 4 illustrates a graphical user interface supporting a log-in process at the random partial pattern data entry state used in one example of an authentication program according to the present invention.

FIG. 5 illustrates a graphical user interface supporting a log-in process at the random partial pattern data entry state, in which field contents have been entered for a random subset of data fields, as used in one example of an authentication program according to the present invention.

FIGS. 6A-6D illustrate an “object repetition method”, “conditional key method”, “field compliant method”, and “even-odd method” for pattern generation according to a cognitive function of position in an ordered set of data fields.

FIG. 7 illustrates client/server architecture for implementation of a user authentication process based on a random partial digitized path recognition RPDPR algorithm according to the present invention.

FIG. 8 is a flowchart of a basic random partial digitized path recognition RPDPR authentication session according to the present invention.

FIGS. 9A-9F provide a secret full digitized path selection menu and various examples of full continuous paths having ten positions for online user account set up in support of the RPDPR authentication process during the login sessions according to the present invention.

FIGS. 10A-10F provide various examples of full non-continuous paths having ten positions for online user account set up in support of the RPDPR authentication process during the login sessions according to the present invention.

FIG. 11 illustrates a graphical user interface supporting a log-in process at the random partial path data entry state used in one example of an authentication program according to the present invention.

FIG. 12 illustrates a graphical user interface supporting a log-in process at the random partial path data entry state used in one example of a strong authentication program combining SSPR and RPDPR algorithms according to the present invention.

FIG. 13 illustrates a graphical user interface supporting a log-in process at the random partial pattern data entry state used in one example of a strong authentication program combining SSPR and RPPR algorithms according to the present invention.

FIG. 14 illustrates a graphical user interface supporting a log-in process at the random partial path/pattern data entry state used in one example of a strong authentication program combining RPDPR and RPPR algorithms according to the present invention.

FIG. 15 illustrates a graphical user interface supporting a log-in process at the random partial path/pattern data entry state used in one example of a strong authentication program combining SSPR, RPDPR, and RPPR algorithms according to the present invention.

FIG. 16 is a basic architecture diagram for an embodiment of a client/server system according to the present invention, including support for the RPPR and RPDPR authentication processes.

### DETAILED DESCRIPTION

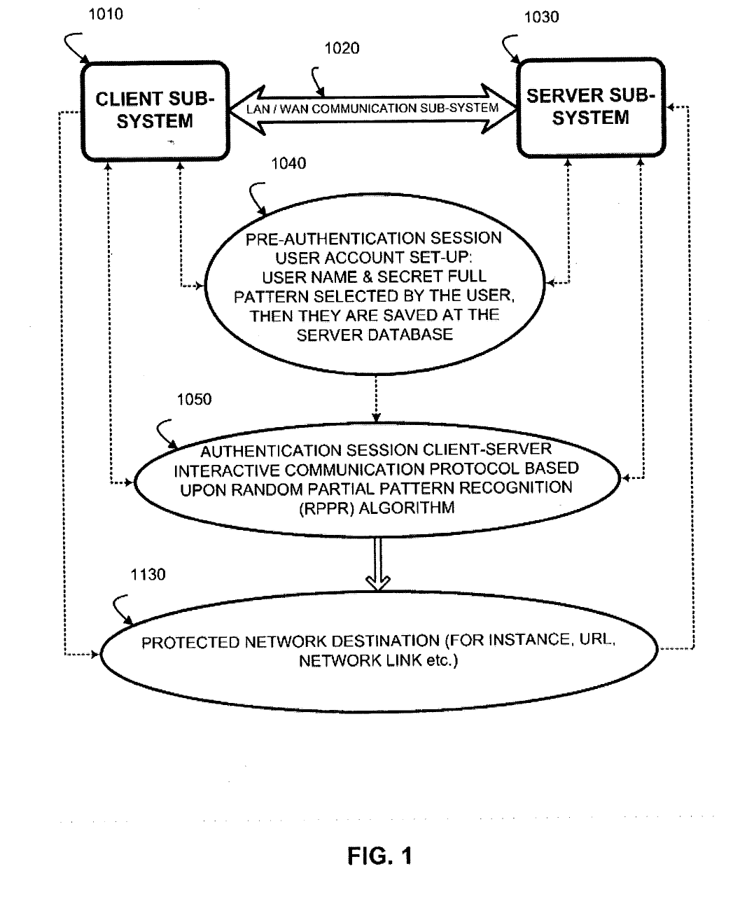

A detailed description of embodiments of the present invention is provided with reference to FIGS. 1 through 16. The RPPR authentication factor is described, followed by a description of the RPDPR authentication factor, and descriptions of procedures utilizing combinations of SSPR, RPPR and RPDPR.

FIG. 1 illustrates a basic communication set up for RPPR authentication processes according to the present invention. A client subsystem 1010 communicates by communication media, such as a local area network or wide area network communications subsystem 1020, with a server subsystem 1030. A protected network destination 1130 controls access to resources such as secure web sites identified by URLs, links to secure networks, and the like.

To set up access, a pre-authentication session 1040 is executed by the client subsystem 1010 and server subsystem 1030. In the pre-authentication session 1040, a user account is set up in the server subsystem 1030, the user name and a secret pattern that includes an ordered data set of data fields is selected by the user and stored in the server subsystem 1030. In the ordered data set, the data fields have a position in the data set and have respective field contents. For RPPR, the field contents are related by a cognitive function of their respective positions in the data set. The user account information, user name and ordered data set of data fields for a first authentication factor are stored in a secure server database. In strong authentication embodiments, at least one additional parametrically independent data set for a second authentication factor is included in the database for the user accounts.

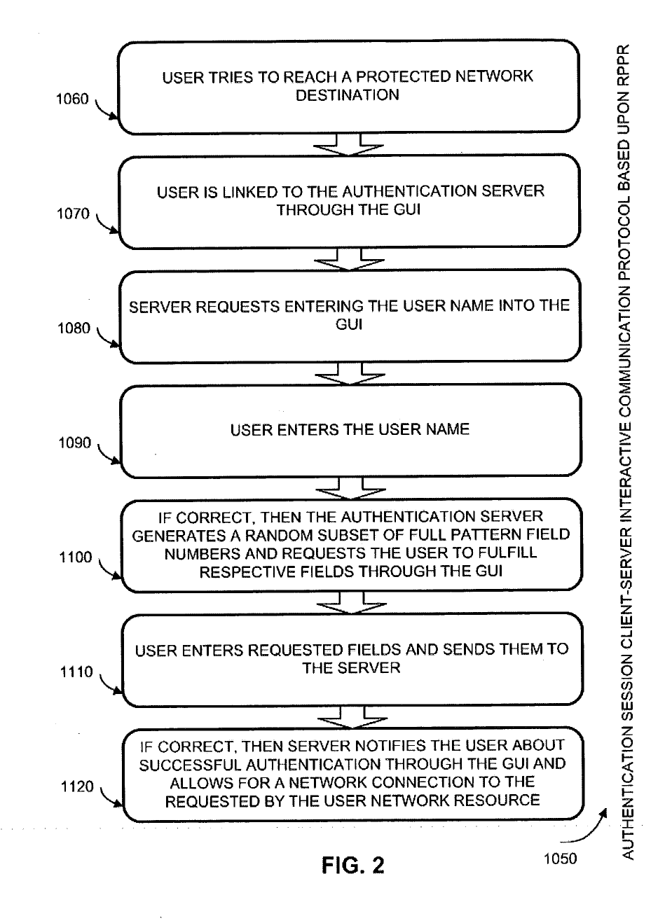

To gain access to the protected network destination 1130, the client subsystem 1010 and server subsystem 1030 execute an authentication session 1050 that includes a client/server interactive communication protocol based on RPPR. A more detailed description of an embodiment of an authentication session 1050 is provided with reference to FIG. 2.

According to one basic flow, an authentication session is initiated when the user tries to reach a protected network destination (block 1060). The protected network destination redirects the user's attempted access to the authentication server, or the attempted access is otherwise detected at the authentication server 1030. In one example, where the user is attempting access using an Internet browser, a communication interface is returned to the user's browser including a graphical user interface including links to the authentication server 1030 (block 1070). The communication interface may be returned through redirection for example, by the authentication server or another network resource. Via the graphical user interface, the server prompts the user to enter a user name into a field in the graphical user interface (block 1080). The user enters the user name, which is returned to the authentication server (block 1090). If the user name is valid, then the authentication server identifies a random partial subset of data fields from the ordered data set of data fields associated with that user name. The user is prompted to enter field contents for the random partial subset of data fields using the graphical user interface (block 1100). The user inputs data for the field contents in the identified fields, and the input data are returned to the server (block 1110). If the input data matches the field contents for the random subset, then successful authentication is signaled to the user via for example the graphical user interface, signaled to the protected network destination and/or signaled to other resources, such as authorization and accounting systems, that need to know that the authentication session has succeeded, and network connection to the requested protected network destination is allowed (block 1120).

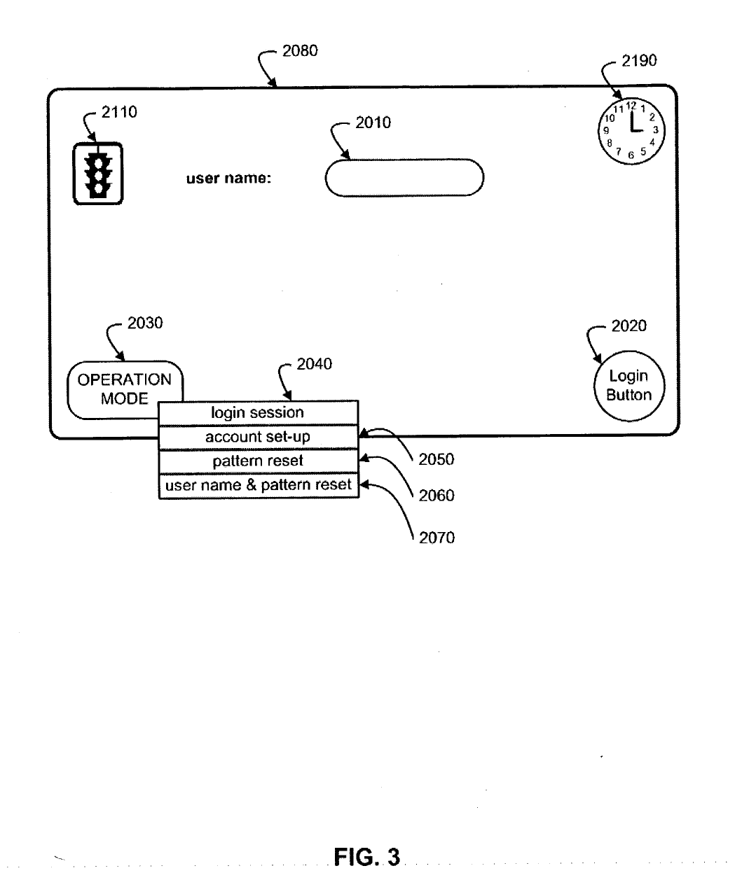

FIGS. 3-5 illustrate input constructs based on graphical user interfaces presented using Web browsers for a login and authentication session based on RPPR. FIG. 3 illustrates an opening screen 2080 which is presented to the user at the beginning of an authentication session. In the opening screen 2080, data entry field 2010 is used for entry of the user name. A login button 2020 is indicated to initiate processing of field data and to start the login process. An operation mode button 2030 is included, which when indicated causes a pop-up menu of operation mode buttons, including a login session operation mode button 2040, an account set up operation mode button 2050, a pattern reset operation mode 2060, and an user name and pattern reset operation mode 2070. A first stoplight icon 2110 is included in the screen 2180. The stoplight icon 2110 shows red before the user name is entered, shows yellow during client/server communications while the client is waiting for verification of the user name, and turns green when user name is accepted. Also included in the screen 2110 is a session timer icon indicating elapsed time for the login session. The system administrator can set parameters in the server that cause reset of the login process if the timer expires, or otherwise react to timer expiry.

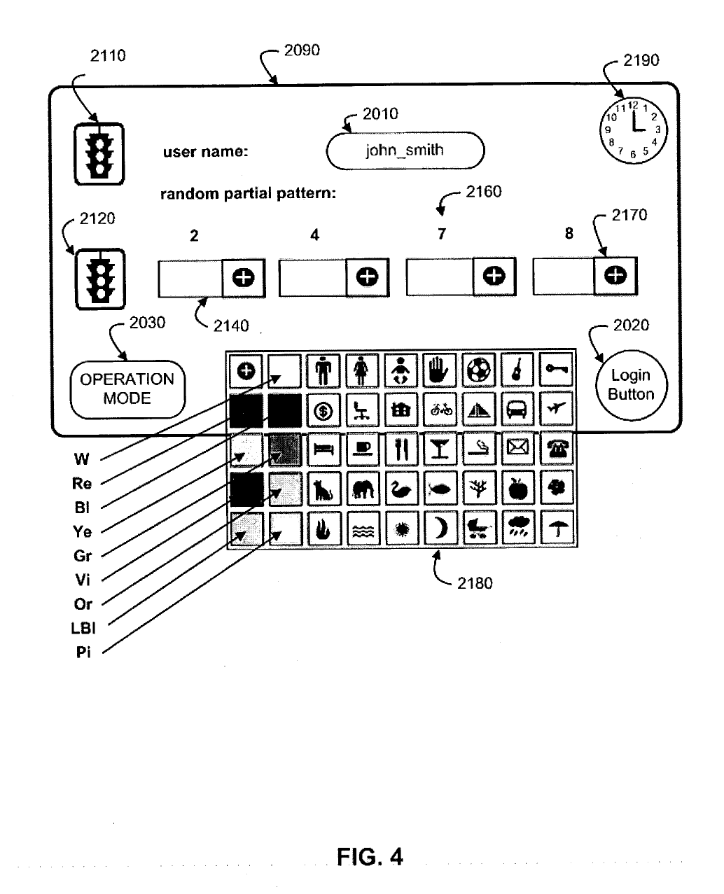

FIG. 4 illustrates a graphical user interface screen 2090, which is presented at the beginning of an authentication session, at the same time as or after the user name is recognized by the server. In this example, two stoplight icons 2110, 2120 are presented. The first stoplight icon 2110 turns green after the user name has been recognized. The second stoplight icon 2120 appears during data entry for the random partial subset. It appears red before data has been entered into data fields, or before the log-in button is indicated. The stoplight icon 2120 appears yellow during client/server communications and before acceptance of the input data representing field contents. The stoplight icon 2120 appears green to signal successful authentication.

The entered and accepted user name could be displayed in the user name field 2010, either as usual text or as sequence of echo dots for security reasons. Data entry fields (e.g. 2140) are presented for a pattern comprising a corresponding number of fields which will constitute the random partial subset of the data set of data fields that defines the full pattern stored for the user. In this example, the random partial subset is presented to the user by field number (e.g. 2160) corresponding to position in the data set, and includes field number 2, field number 4, field number 7 and field number 8, out of an ordered set of for example 9 data fields. In this embodiment, associated with each of the data entry fields is a button 2170 with a corresponding window for entry of an image and color selected by the user. By indicating a button 2170, a pop-down menu 2180 of candidate colors and image icons is displayed which is used as a data entry tool for entry of the field contents for the ordered set of data fields. In this example, the pop-down menu 2180 includes a set of candidate colors, implemented in this example as background colors in the first two columns of the menu 2180 (except for the cross icon used for closing the menu), and a set of candidate image icons in the last seven columns of the menu 2180. The colors in this embodiment include W-white, B1-blue, Gr-green, Or-orange, Pi-pink, LB1-light blue, Vi-violet, Ye-yellow, and Re-red. The user enters alphanumeric characters in a first window in the field 2140 using a keyboard or other input device, and may select an image icon and a background color in a second window 2170 as part of the field contents using a mouse or other input device over the menu 2180. In this example, the random subset includes four fields. Other numbers of fields may be used. Also, the number of fields may be varied from session to session for added security.

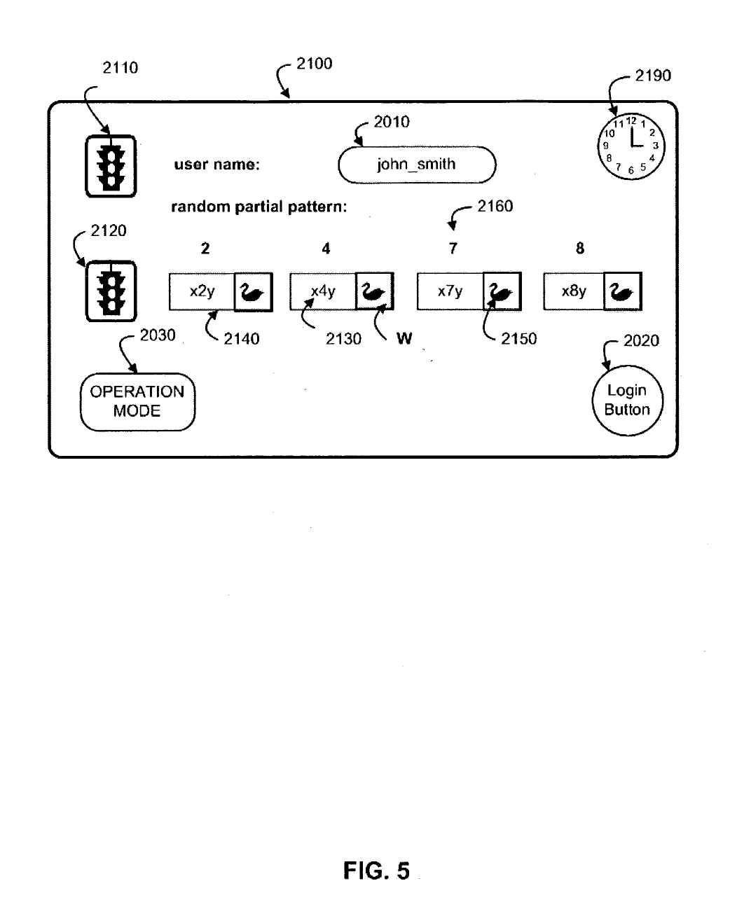

FIG. 5 illustrates the next screen 2100 presented to the user during the RPPR authentication session. In FIG. 5, the user has entered alphanumeric characters in the fields (e.g. 2130) and an image icon (Swan) with background color (White) in the field 2150 (the background color is indicated by the label “W” beneath the field in the drawing, but appears as the color of the background for the image icon, which is black, in the field 2150 in preferred embodiments). Other ways to include color in the field contents include providing a background color for field 2140, a color for the image icons, a color for the alphanumeric characters, and so on. A simple pattern which is a cognitive function of position in the data set is illustrated in this example, where the field contents for the data fields in the data set include the alphanumeric characters x(N)y, where (N) is a digit representing field position in data set, and the black Swan image icon on the white background. After entry of the input data representing field contents for the random partial subset, the user indicates the login button to initiate communication with server. After the server processes the input data, the authentication process is completed as described above.

The RPPR algorithm is based on a random subset of data fields from a full data set, where the field contents in some embodiments represent a pattern that is a function of position in the data set to facilitate user memorization. Of course, any pattern of field contents may be used, including purely random field contents, provided the client is able to recall the field contents for the random partial subset of the full pattern during login, as may be the case for authentication of hardware devices. A random subset that is usually less than the full ordered set is requested by the server from a client during each login/access session.

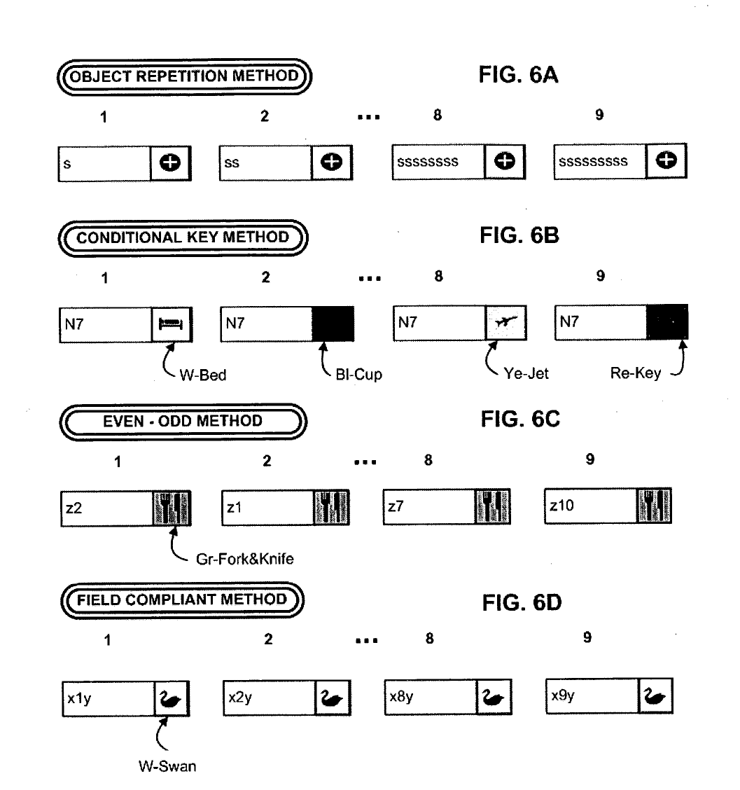

FIGS. 6A-6D illustrate several methods for building patterns based on cognitive functions of position in the ordered set of data fields, which are easy to remember and operate.

FIG. 6A illustrates the basic Object Repetition Method (ORM). In the illustrated example, the field contains a single character “s” which is repeated for a number of times based on the field number within ordered set. Thus, the field contents of data field 1 is “s”, the field contents of data field 2 is “ss”, and so on until the field contents of data field 9 consists of “sssssssss”. More elaborated ORM patterns may be made in this manner.

Basically, the object repetition method involves selecting a relatively simple object, which is easy to remember, like

1. Any character: 1, a, . . .

2. Any simple combination of characters: 12, ab, 1a, 2b, . . .

3. Any color and one character combination: 1-Green, a-Red, . . .

4. Any one character—image/background color combination: 1-YellowBed, 2-RedDog,

5. Any color and any several character combination: 12-Green, ab-Red, 1a-Green, 2b-Red, . . .

6. Any two character combination and any image/background color combination: 12-YellowBed, ab-RedDog

7. Any three character combination and any image/background color combination: 123-YellowBed, abc-RedDog

Representative n-field patterns for the object repetition methods outlined above (assuming 9 fields in the full pattern): look as follows

1. 1, 11, . . . , 111111111; a, aa, aaa, . . . , aaaaaaaaa

2. 12, 1212, 121212, . . . , 121212121212121212; ab, abab, ababab, ababababababababab ; 1a, 1a1a, 1a1a1a, . . . , 1a1a1a1a1a1a1a1a1a

3. 1-Green, 11-Green, 111-Green, . . . , 111111111-Green; a-Red, aa-Red, aaa-Red, . . . , aaaaaaaaa-Red

4. 1-YellowBed, 11-YellowBed, 111-YelowBed, . . . , 111111111-YellowBed; 2-RedDog, 22-RedDog, 222-RedDog, . . . , 222222222-RedDog

5. 12-Green, 1212-Green, 121212-Green, . . . , 121212121212121212-Green; ab-Red, abab-Red, ababab-Red, . . . , ababababababababab-Red; 1a-Green, 1a1a-Green, 1a1a1a-Green, . . . , 1a1a1a1a1a1a1a 1a1a-Green; 2b-Red, 2b2b-Red, 2b2b2b-Red, . . . 2b2b2b2b2b2b2b2b2b-Red

6. 12-YellowBed, 1212-YellowBed, 121212-YellowBed, . . . , 121212121212121212-YellowBed; ab-RedDog, abab-RedDog, abababRedDog, . . . ababababababababab-RedDog

7. 123-YelowBed, 123123-YellowBed, 123123123-YellowBed, . . . 123123123123123123123123123-YellowBed or abc-RedDog, abcabc-RedDog, abcabcabc-RedDog, . . . , abcabcabcabcabcabcabcabcabc-RedDog

Another method is referred to as the Conditional Key Method (CKM) is illustrated in FIG. 6B. According to the conditional key method of FIG. 6B, alphanumeric character N7 is entered into data field for each position in the pattern, and a graphical icon and background color are selected according to a simple pattern. Referring to FIG. 6B, the pattern begins in data field 1 with the bed image icon and a white background. Data field 2 is the coffee cup with the blue background. Data field 3 (not shown) is the knife and fork image icon with the green background. Data field 4 is the martini glass image icon with the orange background. Data field 5 is the cigarette icon with the pink background. Data field 6 is an envelope image icon with the light blue background. Data field 7 is the telephone image icon with the violet background. Data field 8 is the airplane image icon with the yellow background. Data field 9 is the key image icon with the red background. In this example, image icons are selected by traversing the row that begins with the bed icon to the right, and then at the end of the row proceeding up the last column in the set of candidate image icons in a counter-clockwise direction. The background colors are also selected by following a simple pattern in the candidate background colors, preceding down the column that begins with the white background color to the bottom of the column, and then up the column of background colors in a clockwise direction, making an easy to remember cognitive function of position in the ordered set. Other conditional key codes are based on the process of selecting a relatively simple object, like any combination of alphanumeric characters (from 1 to 3 characters) and one color from the candidate image/color menu. For instance, one could choose 123-Pink or abc-Pink. The unchanging roots here are 123 or abc, which will be kept the same in all of the n data fields (without sacrificing any generality, we are assuming 9 fields pattern sizes here). One could then use and remember Pink and its color position in the menu as a conditional key and find others, changing along with field number, either clockwise or counter-clockwise (let's choose clockwise for clarity). One could then select any combination of alphanumeric characters (from 1 to 3 characters) and one image from the candidate image icon menu, for instance, 123-Sun or abc-Sun. For example, a user could use and remember the sun image and its position as a conditional key and find others, by proceeding either clockwise or counter-clockwise (let's choose counter-clockwise for clarity). An object pattern is built based on these techniques. For instance, 123-PinkSun. As fields are changing, so are colors and images with respect to conditional keys selected in the initial object 123-PinkSun. Assuming that colors will be changing clock-wise, whereas images will be changing counter-clockwise with respect to their conditional keys (Pink and Sun) positions, representative n-field patterns look as follows (assuming 9 fields full patterns):

1. Static alphanumeric characters with conditional color: 123-Pink, 123-LightBlue, 123-Violet, 123-Yellow, 123Red, 123-White, 123-Blue, 123-Green, 123-Orange, or abc-Pink, abc-LightBlue, abc-Violet, abc-Yellow, abc-Red, abc-White, abc-Blue, abc-Green, abc-Orange

2. Static alphanumeric characters with conditional image: 123-Sun, 123-Moon, 123-Stroller, 123-Rain, 123Umbrella, 123-Flower, 123-Telephone, 123-Jet, 123-Key, 123-Giutar, or abc-Sun, abc-Moon, abc-Rain, abc-Umbrella, abc-Flower, abc-Telephone, abc-Jet, abcKey, abc-Gitar

3. Static alphanumeric characters with conditional color and conditional image: 123-PinkSun, 123-LightBlueMoon, 123-VioletStroller, 123-YellowRain, 123-RedUmbrella, 123-WhiteFlower, 123-BlueTelephone, 123-GreenJet, 123-OrangeKey

It is interesting to note that an SSPR implementation would have to utilize 20-21 character static PINs or passwords (totally unrealistic case) to achieve the same level of combinatorial security, as described above methods (assuming five objects per field and four out of nine fields partial patterns (an object is any of either a alphanumeric character, or a background color, or an image icon )).

FIG. 6C illustrates a basic even-odd method (EOM) for defining field contents for an ordered set of data fields according to cognitive function of position in the ordered set. According to the even-odd method, the field contents for odd-numbered fields consists of the letter “z” any number equal to the field number plus 1. For even-numbered fields, the field contents consist of the letter “z” and a number equal to the field number minus 1. Thus, the field contents for data field 1 are z2. In data field 2, the field contents are z1. The pattern repeats so that in data field 8, the field contents are z7. In data field 9, the field contents are z10. According to one even-odd method, the user selects two secret algorithm meters—one for even and another one for odd fields. For example:

1. Even fields algorithm: data field 2→2+1=3, data field 4→4+1=5, etc.; Odd fields algorithm: data field 1→1−1=0, data field 3→3−1=2, etc. Eventually the pattern looks as follows: 0, 3, 2, 5, 4, 7, 6, 9, 8.

2. Even fields algorithm: 2→100−2=98, 4→100−4=96, etc. Odd fields algorithm: 1→1, 3→3, 5→5, etc. Eventually the pattern looks as follows: 1, 98, 3, 96, 5, 94, 7, 92, 9

3. Even fields algorithm: 2→2\hat{ }2−2=2, 4→4\hat{ }2−4=12, 6→6\hat{ }2−6=30, etc.; Odd fields algorithm: 1→1\hat{ }2+1=2, 3→3\hat{ }2+3=12, 5→5\hat{ }2+5=30, etc. Eventually the pattern looks as follows: 2, 2, 12, 12, 30, 30, 56, 56, 90

4. Even fields algorithm: 2→22, 4→44, etc. Odd fields algorithm: 1→11111, 3→33333, etc. Eventually the pattern looks as follows: 11111, 22, 33333, 44, 55555, 66, 77777, 88, 99999

EOM could be easily combined with other functions of position, such as ORM and CKM. For instance, even fields algorithm: 2→222-White (conditional key; clockwise), 4→444-Green, 6→666-Pink, etc.; odd fields algorithm: 1→111-Umbrella (conditional key, counter-clockwise), 3→333-Stroller, 5→555-Sun, etc. Eventually the pattern looks as follows: 111-Umbrella, 222-White, 333-Stroler, 444-Green, 555-Sun, 666-Pink, 777-Flame, 888 -Violet, 999-Bed.

FIG. 6D illustrates the basic Field Compliant Method (FCM) for assigning a cognitive function of position in the development of the field contents for the ordered set of data fields which constitutes the authentication codes. This can be seen in FIG. 6D, the field contents for the data fields consists of x(N)y with a black swan on white background. The parameter (N) represents the field number. Thus, data field 1 includes the field contents x1y-WhiteSwan. Data field 2 includes the field contents x2y-WhiteSwan. The pattern repeats so that the data field 8 includes the field contents x8y-WhiteSwan and the data field 9 includes the field contents x9y-WhiteSwan.

Basically, FCM is based on selecting an object consisting of any combination of characters, colors and/or images to be a root object for all fields. Embed into this object a meter, changing in a strict correspondence to the field sequential number according to a certain secret algorithm. For instance,

1. Root: ab-White. Meter—a number before “ab” corresponding to a field number: 1ab-White, 2ab-White, 3ab-White, . . . , 9ab-White

2. Root: ab-White. Meter—a number after “ab” corresponding to a field number: ab1-White, ab2-White, ab3-White, . . . , ab9-White

3. Root: ab-White. Meter—a number embedded between “a” and “b” corresponding to a field number: a1b-White, a2b-White, a3b,-White, . . . , a9b-White

4. Root: ab-White. Meter—a number before “ab” corresponding to a field number plus 100: 101ab-White, 102ab-White, 103ab-White, . . . , 109ab-White

5. Root: ab-White. Meter—a number after “ab” corresponding to a field number plus 100: b101-White, ab102-White, ab103-White, . . . , ab109-White

6. Root: ab-White. Meter—a number between “a” and “b” corresponding to a field number plus 100: a101b-White, a102b-White, a103b-White, . . . , a109b-White

7. Root: ab-White. Meter—a number before “ab” corresponding to a field number multiplied by 2: 2ab-White, 4ab-White, 6ab-White, . . . , 18ab-White

8. Root: ab-White. Meter—a number after “ab” corresponding to a field number multiplied by 2: ab2-White, ab4-White, ab6-White, . . . , ab18-White

9. Root: ab-White. Meter—a number between “a” and “b” corresponding to a field number multiplied by 2: a2b-White, a4b-White, a6b-White, . . . , a18b-White

10. Root: ab. Meter—a color found from the conditional key (White) clockwise in correspondence to the field number: ab-White, ab-Blue, ab-Green, ab-Orange, ab-Pink, ab-LightBlue, ab-Violet, ab-Yellow, ab-Red

11. Root: ab-White. Meter—an image found from the conditional key (Key) counter-clockwise in correspondence with the field number multiplied by 2: ab-WhiteGuitar, ab-WhiteArm, ab-WhiteGirl, ab-WhiteDollar, ab-WhiteDog, ab-WhiteSee, ab-WhiteMoon, ab-WhiteRain, ab-WhiteFlower

12. Root: Z. Meter—field number before “Z” and behind “Z”: oneZone, twoZtwo, threeZthree, . . . , nineZnine.

These patterns are as easy to remember as 4 character PINs/passwords. However, the combinatorial security is a great deal of stronger for the RPPR based technology, as compared with SSPR algorithm based security systems.

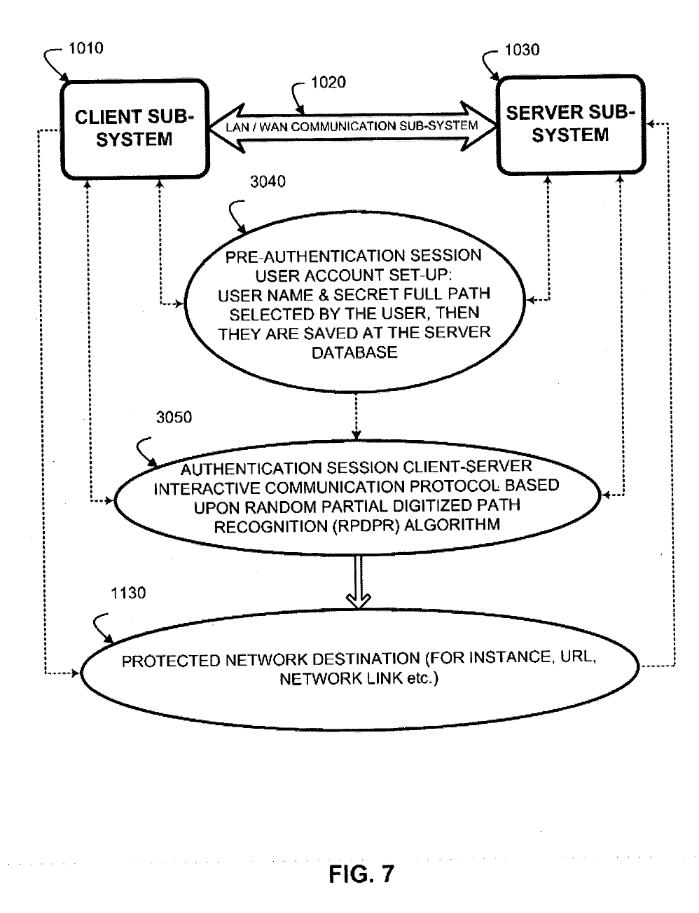

FIG. 7 illustrates a basic communication set up for RPDPR authentication processes according to the present invention. A client subsystem 1010 communicates by communication media, such as a local area network or wide area network communications subsystem 1020, with a server subsystem 1030. A protected network destination 1130 controls access to resources such as secure web sites identified by URLs, links to secure networks, and the like.

To set up access, a pre-authentication session 3040 is executed by the client subsystem 1010 and server subsystem 1030. In the pre-authentication session 3040, a user account is set up in the server subsystem 1030, the user name and a secret digitized path represented by an ordered data set of data fields is selected by the user and stored in the server subsystem 1030. In the ordered data set, the data fields have a position in the data set and have respective field contents. For RPDPR, the field contents include combinations of field coordinates on a frame of reference of points characterizing data field locations along a directed digitized path on the frame of reference. The position in the data set corresponds to the position of a corresponding point on the directed digitized path, which has coordinates known to the client on the frame of reference. The position in the data set therefore indicates such coordinates to the client, and the coordinates can be used to select an indicator to be supplied as a part of the authentication factor that corresponds to the position indicated by the clue.

The user account information, user name and ordered set of data fields are stored in a secure server database, along with such other information utilized during an authentication session. In some embodiments, information supporting additional authentication factors is stored in the database.

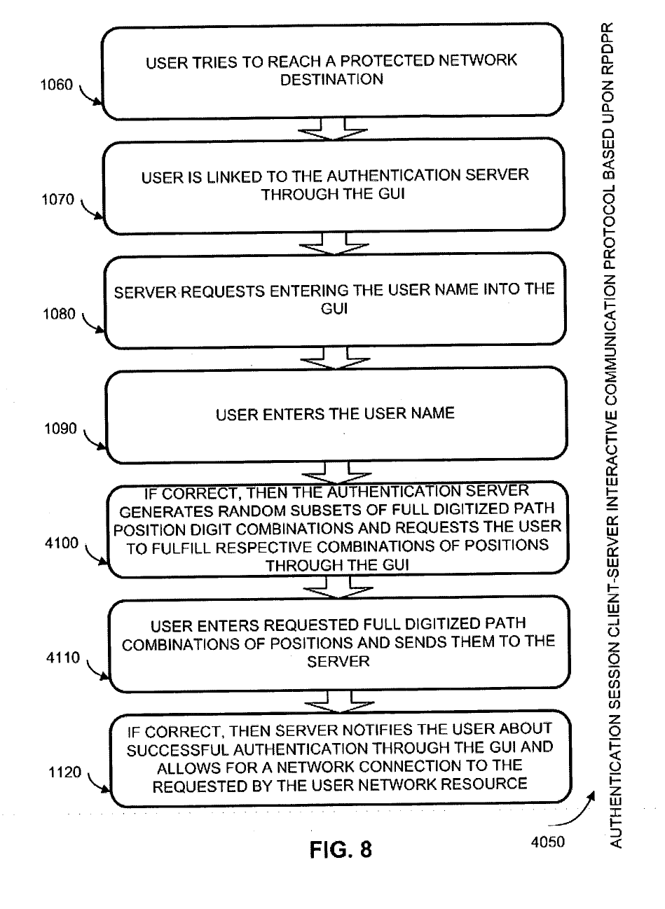

To gain access to the protected network destination 1130, the client subsystem 1010 and server subsystem 1030 execute an authentication session 3050 that includes a client/server interactive communication protocol based on RPDPR. A more detailed description of an embodiment of an authentication session 3050 is provided with reference to FIG. 8. In FIG. 8, blocks corresponding to similar blocks in FIG. 2 have the same reference numerals.

According to one basic flow, an authentication session is initiated when the user tries to reach a protected network destination (block 1060). The protected network destination redirects the user's attempted access to the authentication server, or the attempted access is otherwise detected at the authentication server 1030. In one example, where the user is attempting access using an Internet browser, a communication interface is returned to the user's browser including a graphical user interface including links to the authentication server 1030 (block 1070). The communication interface may be returned through redirection for example, by the authentication server or another network resource. Via the graphical user interface, the server prompts the user to enter a user name into a field in the graphical user interface (block 1080). The user enters the user name, which is returned to the authentication server (block 1090). If the user name is valid, then the authentication server identifies a random partial subset of data fields from the ordered data set of data fields that have field contents indicating coordinates of a set of points that together define a full digitized path on the frame of reference. For instance, in one embodiment there are ten data fields comprising a full digitized path with the starting path field having position 0, next consecutive data field having position 1, and going alike up to the last data field at the full digitized path end having position 9. Then, random partial subsets identified by the authentication server (a clue) and presented to the user through the graphical user interface will look like a random set of random digit combinations, for example, 24, 019, 7, 68. The user is prompted to fulfill input field values that correspond to the coordinates in member data fields in the random partial subset of data fields using the graphical user interface (block 4100). In one example, the input field values are selected from an array of indicators located on an instance of the frame of reference, where the indicators in the array have locations on the instance of the frame of reference corresponding to candidate coordinates in the frame of reference. The user inputs the indicators, or other data corresponding to the coordinates for the random partial subset of the digitized path, for the input field contents, and the input data are returned to the server (block 4110). If the input data matches the field contents for the random subset, then successful authentication is signaled to the user via for example the graphical user interface, signaled to the protected network destination and/or signaled to other resources, such as authorization and accounting systems, that need to know that the authentication session has succeeded, and network connection to the requested protected network destination is allowed (block 1120).

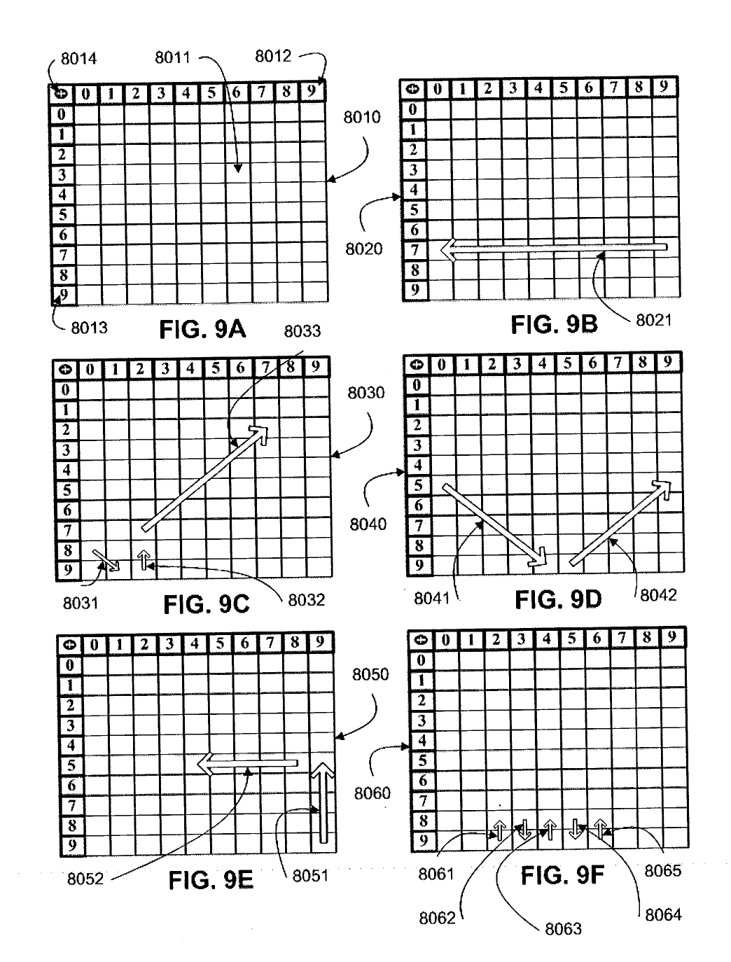

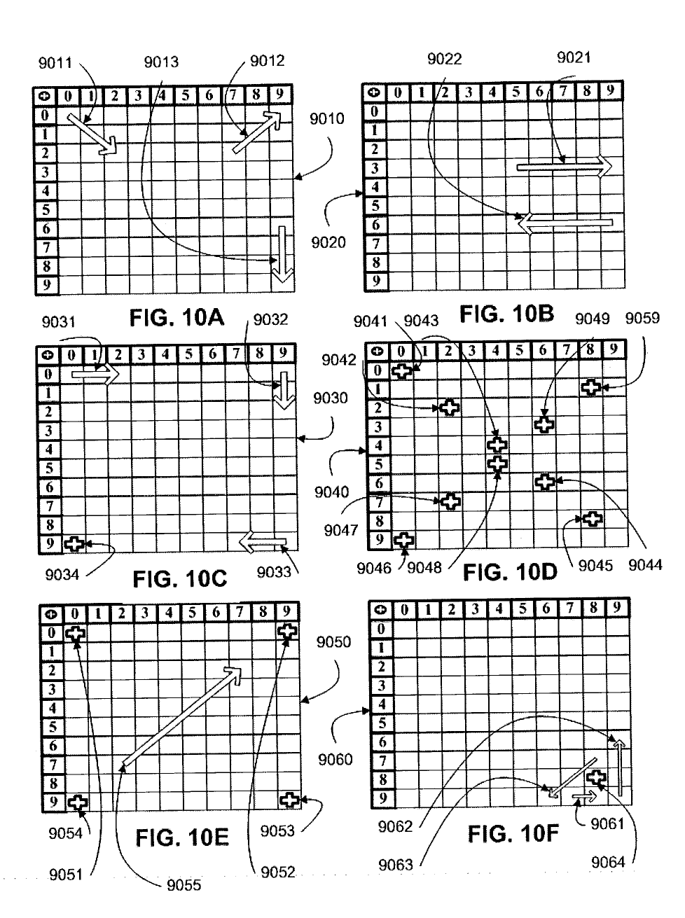

FIGS. 9A-9F and 10A-10F illustrate how a digitized path is specified with respect to a frame of reference for use as a RPDPR authentication factor. In this example, the frame of reference consists of a reference grid as shown in FIG. 9A. The reference grid 8010 in this embodiment consists of an array of locations (e.g. 8011) that can be characterized by coordinates along horizontal and vertical axes 8012, 8013 respectively, as in a Cartesian coordinates system. Other frames of reference may be organized according to other coordinate systems, such as polar coordinate systems. In the example shown in FIG. 9A the location 8011 can be characterized by coordinates (6, 3). FIG. 9A represents an instance of a frame of reference for display on a user interface during an account setup procedure for example, used by a client to specify a full digitized path. Thus, the instance includes icon 8014 at the intersection of the reference axes, used as a button for opening and closing the instance. The client may draw (or choose, or select)) a path on the reference grid with a mouse, a keyboard, or other input devices, or the path may be provided by a server, as suits a particular instance of the set up algorithm.

FIGS. 9B-9F illustrate representative digitized paths which can be set up using the frame of reference 8010. Thus, FIG. 9B illustrates a path 8021 on an instance 8020 of the reference grid. The path includes a set of points beginning with a point at coordinates (9, 7). The path proceeds in a straight line in order with points at the coordinates (8, 7), (7, 7), (6, 7), . . . (0, 7). A data set corresponding with this digitized path comprises a set a data fields having positions 0 through 9 in the data set (where the positions can be represented by a field number using a data set that comprises a linear array of data fields). The data fields at the 10 positions respectively store combinations of coordinates (9, 7) through (0, 7) in order. In this manner, if the client knows the path and the location of a data fields in the data set, the client can determine the coordinates stored in the data field. Those coordinates can be used to fulfill the authentication factor as described below.

FIG. 9C illustrates a path represented by arrows 8031, 8032, 8033 on an instance 8030 of the frame of reference. The path of FIG. 9C, includes the coordinates in order: (0,8), (1,9), (2,9), (2,8), (2,7), (3,6), (4,5), (5,4), (6,3), and (7,2). These coordinates are stored in the data fields having positions 0 through 9 respectively in the data set used as the authentication factor based on the path in FIG. 9C.

FIG. 9D illustrates a path represented by arrows 8041, 8042 on an instance 8040 of the frame of reference. The path of FIG. 9D includes the coordinates in order: (0,5), (1,6), (2,7), (3,8), (4,9), (5,9), (6,8), (7,7), (8,6), and (9,5). These coordinates are stored in the data fields having positions 0 through 9 respectively in the data set used as the authentication factor based on the path in FIG. 9D.

FIG. 9E illustrates a path represented by arrows 8051, 8052 on an instance 8050 of the frame of reference. The path of FIG. 9E, includes the coordinates in order: (9,9), (9,8), (9,7), (9,6), (9,5), (8,5), (7,5), (6,5), (5,5), and (4,5). These coordinates are stored in the data fields having positions 0 through 9 respectively in the data set used as the authentication factor based on the path in FIG. 9E.

FIG. 9F illustrates a path represented by arrows 8061, 8062, 8063, 8064, 8065 on an instance 8060 of the frame of reference. The path of FIG. 9F, includes the coordinates in order: (2,9), (2,8), (3,8), (3,9), (4,9), (4,8), (5,8), (5,9), (6,9), and (6,8). These coordinates are stored in the data fields having positions 0 through 9 respectively in the data set used as the authentication factor based on the path in FIG. 9F.

The digitized paths shown in FIGS. 9B through 9F are considered herein continuous digitized paths, because all of the coordinates on the path are adjacent to other coordinates on the path in order. Continuous paths may be easier to remember for some clients.

Also, all of the representative digitized paths have the same number of points. Using the same number of points on each path facilitates the execution of the RPDPR authentication algorithm, but is not necessary to the concept of the RPDPR authentication factor from client to client.

Other embodiments of the invention use digitized paths that are non-continuous, such as described of reference to FIGS. 10A-10F.

FIG. 10A illustrates a non-continuous path represented by arrows 9011, 9012, 9013 on an instance 9010 of the frame of reference. The path of FIG. 10A, includes the coordinates in order: (0,0), (1,1), (2,2), (7,2), (8,1), (9,0), (9,6), (9,7), (9,8), and (9,9). A discontinuity in the path occurs between the coordinates (2, 2) and (7, 2). Also, a discontinuity occurs between the coordinates (9, 0) and (9, 6). These coordinates are stored in the data fields having positions 0 through 9 respectively in the data set used as the authentication factor based on the path in FIG. 10A.

FIG. 10B illustrates a non-continuous path represented by arrows 9021, 9022 on an instance 9020 of the frame of reference. The path of FIG. 10B, includes the coordinates in order: (5, 3), (6, 3), (7, 3), (8, 3), (9, 3), (9, 6), (8, 6), (7, 6), (6, 6), and (5, 6). These coordinates are stored in the data fields having positions 0 through 9 respectively in the data set used as the authentication factor based on the path in FIG. 10B.

FIG. 10C illustrates a non-continuous path represented by arrows 9031, 9032, 9033 and cross 9034 on an instance 9030 of the frame of reference. The path of FIG. 10C, includes the coordinates in order: (0, 0), (1, 0), (2, 0), (9, 0), (9, 1), (9, 2), (9, 9), (8, 9), (7, 9), and (0, 9). These coordinates are stored in the data fields having positions 0 through 9 respectively in the data set used as the authentication factor based on the path in FIG. 10C.

FIG. 10D illustrates a non-continuous path represented by crosses 9041, 9042, 9043, 9044, 9045, 9046, 9047, 9048, 9049, 9059 on an instance 9040 of the frame of reference. The path of FIG. 10D, includes the coordinates in order: (0, 0), (2, 2), (4, 4), (6, 6), (8, 8), (0, 9), (2, 7), (4, 5), (6, 3), and (8, 1). These coordinates are stored in the data fields having positions 0 through 9 respectively in the data set used as the authentication factor based on the path in FIG. 10D.

FIG. 10E illustrates a non-continuous path represented by crosses 9051, 9052, 9053, 9054 and arrow 9055 on an instance 9050 of the frame of reference. The path of FIG. 10E, includes the coordinates in order: (0, 0), (9, 0), (9, 9), (0, 9), (2, 7), (3, 6), (4, 5), (5, 4), (6, 3), and (7, 2). These coordinates are stored in the data fields having positions 0 through 9 respectively in the data set used as the authentication factor based on the path in FIG. 1E.

FIG. 10F illustrates a non-continuous path represented by arrows 9061, 9062, 9063 and cross 9064 on an instance 9060 of the frame of reference. The path of FIG. 10F, includes the coordinates in order: (7, 9), (8, 9), (9, 9), (9, 8), (9, 7), (9, 6), (8, 7), (7, 8), (6, 9), and (8, 8). These coordinates are stored in the data fields having positions 0 through 9 respectively in the data set used as the authentication factor based on the path in FIG. 10F.

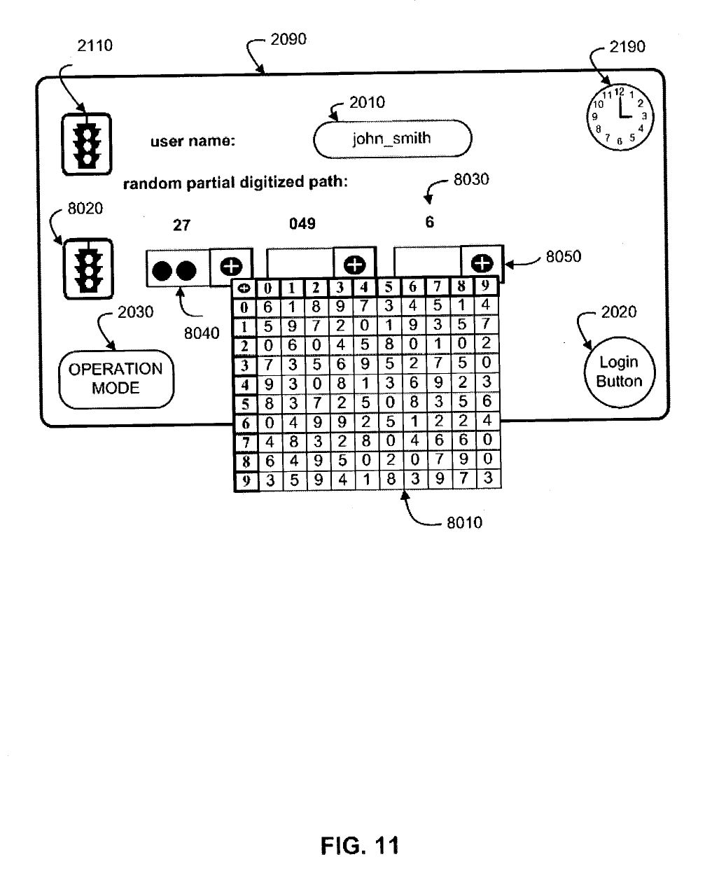

FIG. 11 illustrates a graphical user interface screen 2090, which is presented at the beginning of an authentication session based on RPDPR alone, after the user name in field 2010 is recognized by the server. After acceptance of the user name, the interface 2090 prompts the client for fulfillment of the RPDPR authentication factor. Otherwise, if the user name is not accepted by the authentication server, “random partial digitized path” prompt and its respective objects, and the second stop light icon 8020 do not appear in screen 2090, while the first stop light icon 2110 will turn red signaling access denied (or user name is incorrect). In this example, two stoplight icons 2110, 8020 are presented. The first stoplight icon 2110 turns green after the user static password has been recognized. The second stoplight icon 8020 appears during data entry for the random partial subset. It appears red before data has been entered into data fields, or before the login button is indicated. The stoplight icon 8020 appears yellow during client/server communications and before acceptance of the input data representing field contents. The stoplight icon 8020 appears green to signal successful authentication.

The entered and accepted user name could be displayed in the user name field 2010, either as usual text or as sequence of echo dots for security reasons. Data entry fields (e.g. 8040) are presented for a pattern comprising a corresponding number of fields which will constitute the random partial subset of the data set of data fields stored for the user. In this example, a plurality of the random partial subsets are presented to the user by sets of field position numbers (e.g. 8030), and includes set of field position numbers 27, set of field position numbers 049, field position number 6, out of a data set of for example 10 data fields corresponding to a digitized path comprising 10 points. In this embodiment, associated with each of the data entry fields is a button 8050 with a corresponding window for entry of indicators selected by the user. By indicating a button 8050, a pop-down menu 8010 is displayed. The pop-down menu 8010 comprises an instance of a reference grid, such as shown in FIGS. 9A-9F and 10A-10F, where the points on the grid are populated by a randomized array of indicators. Thus, an indicator at the point having coordinates (4, 5) is the digit 5. The server produces a different instance of the array of indicators for each instance of the reference grid. The different instances of the array of indicators can be generated randomly, or pseudo- randomly, in preferred embodiments. Alternatively, a set of previously generated arrays of indicators can be utilized in a random order. Other techniques can be utilized for making the presentation of the arrays of indicators variable to strengthen the authentication factor.

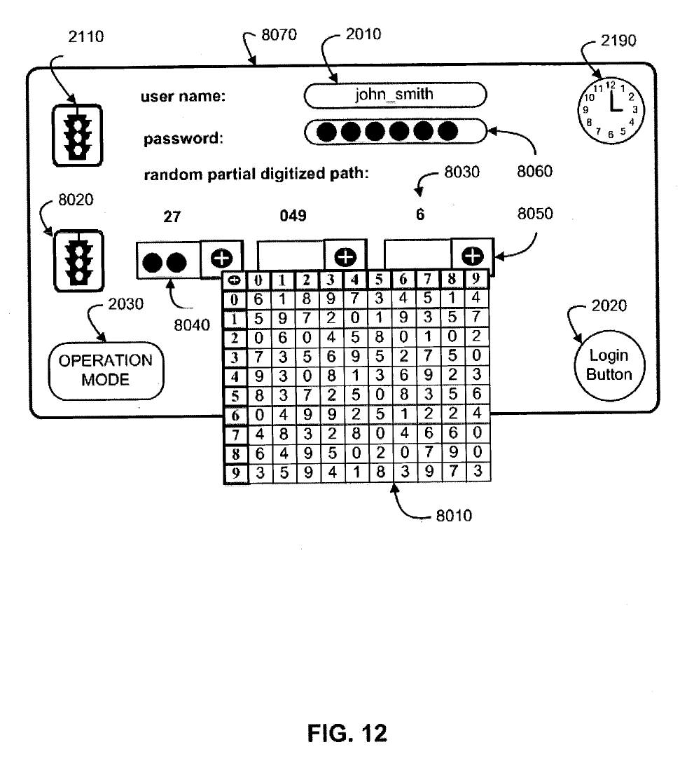

The graphical user interface 2090 presents clues represented by the sets the field position numbers (e.g. 8030). Corresponding input fields 8040 are presented to the user. The user fulfills the authentication factor by including the indicators from the points on the reference grid having the coordinates that correspond to the field position numbers in the sets the field position numbers that identify the random partial subset of the full path, associated as clues with the input fields. Thus, in the input fields corresponding to the set of field position numbers 27, for a full digitized path as shown in FIG. 9B, the indicators chosen will be the indicator at the coordinates stored in field position number 2 and at the coordinates stored in field position number 7 of the full data set. Field position number 2 in the example of FIG. 9B stores the coordinates (7, 7). The indicator at the coordinates (7, 7) is the digit 6. The field position number 7 in the example of FIG. 9B stores the coordinates (2, 7). The indicator at the coordinates (2, 7) is the digit 3. Therefore, the input field 8040 is fulfilled by inputting the indicators 6 and 3. A similar procedure is followed to fulfill the fields corresponding to the clues that consist of the sets the field position numbers 049 and 6 for the interface 8070 shown in FIG. 12.

FIG. 12 illustrates a graphical user interface screen 8070, which is presented at the beginning of an authentication session using a strong authentication algorithm, based on a combination of SSPR and RPDPR after the user name in field 2010 is recognized by the server. The screen 8070 includes a password field 8060, into which the client enters a static password. After entry of the static password in field 8060, the interface 8070 prompts the client for fulfillment of the RPDPR authentication factor. Otherwise, if the user name or a password are not accepted by the authentication server, “random partial digitized path” prompt and its respective objects, and the second stop light icon 8020 do not appear in screen 8070, while the first stop light icon 2110 will turn red signaling access denied (or user name and/or password are/is incorrect). In this example, two stoplight icons 2110, 8020 are presented. The first stoplight icon 2110 turns green after the user static password has been recognized. The second stoplight icon 8020 appears during data entry for the random partial subset. It appears red before data has been entered into data fields, or before the login button is indicated. The stoplight icon 8020 appears yellow during client/server communications and before acceptance of the input data representing field contents. The stoplight icon 8020 appears green to signal successful authentication.

The entered and accepted user name could be displayed in the user name field 2010, either as usual text or as sequence of echo dots for security reasons. The static password is preferably displayed using echo dots, as well. Data entry fields (e.g. 8040) are presented for a pattern comprising a corresponding number of fields which will constitute the random partial subset of the data set of data fields stored for the user. In this example, a plurality of the random partial subsets are presented to the user by sets of field position numbers (e.g. 8030), and includes set of field position numbers 27, set of field position numbers 049, field position number 6, out of a data set of for example 10 data fields corresponding to a digitized path. In this embodiment, associated with each of the data entry fields is a button 8050 with a corresponding window for entry of indicators selected by the user. By indicating a button 8050, a pop-down menu 8010 is displayed. The pop-down menu 8010 comprises an instance of a reference grid, such as shown in FIGS. 9A-9F and 10A-10F, where the points on the grid having coordinates are populated by a randomized array of indicators, as described above.

The graphical user interface 8070 presents clues represented by the sets of the field position numbers (e.g. 8030). Corresponding input fields 8040 are presented to the user. The user fulfills the authentication factor by including the indicators from the coordinates that corresponds to the field position numbers in the sets the field numbers associated with the input fields, as described with reference to FIG. 11.

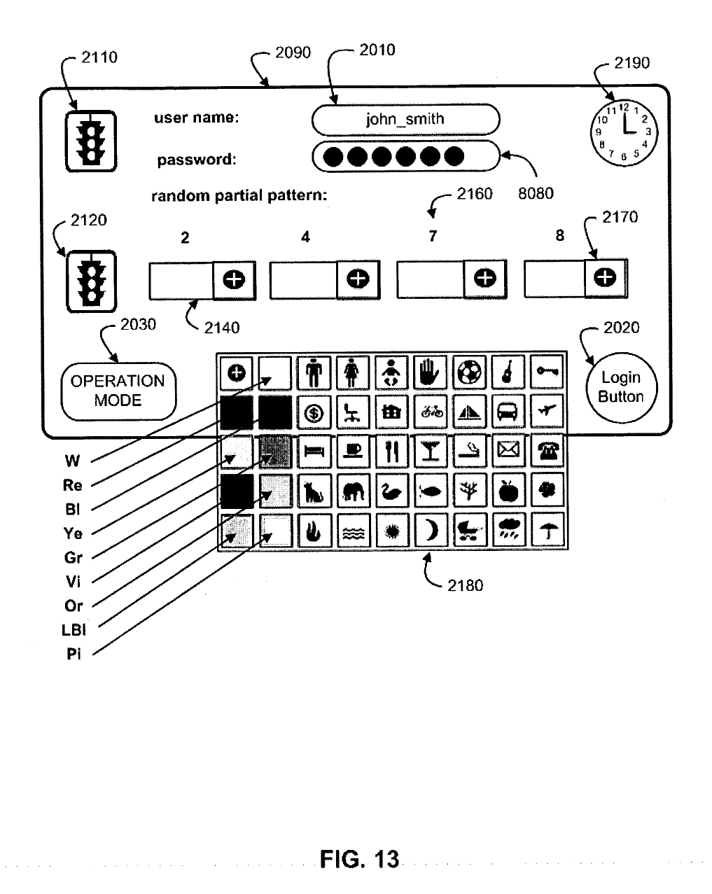

FIG. 13 illustrates a graphical user interface screen 2090, which is presented at the beginning of an authentication session using a strong authentication. This session is based on a combination of SSPR and RPPR after the user name in field 2010 is recognized by the server. The screen 2090 includes a password field 8080, into which the client enters a static password. After entry of the static password in field 8080, the interface 2090 prompts the client for fulfillment of the RPPR authentication factor. Otherwise, if the user name or a password are not accepted by the authentication server, “random partial pattern” prompt and its respective objects, and the second stop light icon 2120 do not appear in screen 2090, while the first stop light icon 2110 will turn red signaling access denied (or user name and/or password are/is incorrect). In this example, two stoplight icons 2110, 2120 are presented. The first stoplight icon 2110 turns green after the user static password has been recognized. The second stoplight icon 2120 appears during data entry for the random partial subset. It appears red before data has been entered into data fields, or before the login button is indicated. The stoplight icon 2120 appears yellow during client/server communications and before acceptance of the input data representing field contents. The stoplight icon 2120 appears green to signal successful authentication.

The entered and accepted user name could be displayed in the user name field 2010, either as usual text or as sequence of echo dots for security reasons. The static password is preferably displayed using echo dots, as well. Data entry fields (e.g. 2140) are presented for a pattern comprising a corresponding number of fields which will constitute the random subset of the ordered set of data fields stored for the user. In this example, the random subset is presented to the user by field number (e.g. 2160), and includes field number 2, field number 4, field number 7 and field number 8, out of an ordered full data set having for example 9 data fields. In this embodiment, associated with each of the data entry fields is a button 2170 with a corresponding window for entry of an image and color selected by the user. By indicating a button 2170, a pop-down menu 2180 of candidate colors and image icons is displayed which is used as a data entry tool for entry of the field contents for the ordered set of data fields. In this example, the pop-down menu 2180 includes a set of candidate colors, implemented in this example as background colors in the first two columns of the menu 2180 (except for the cross icon used for closing the menu), and a set of candidate image icons in the last seven columns of the menu 2180. The colors in this embodiment include W-white, B1-blue, Gr-green, Or-orange, Pi-pink, LBl-light blue, Vi-violet, Ye-yellow, and Re-red. The user enters alphanumeric characters in a first window in the field 2140 using a keyboard or other input device, and may select an image icon and a background color in a second window as part of the field contents using a mouse over menu 2180 or other input device. In this example, the random subset includes four fields. Other numbers of fields may be used. Also, the number of fields may be varied from session to session for added security.

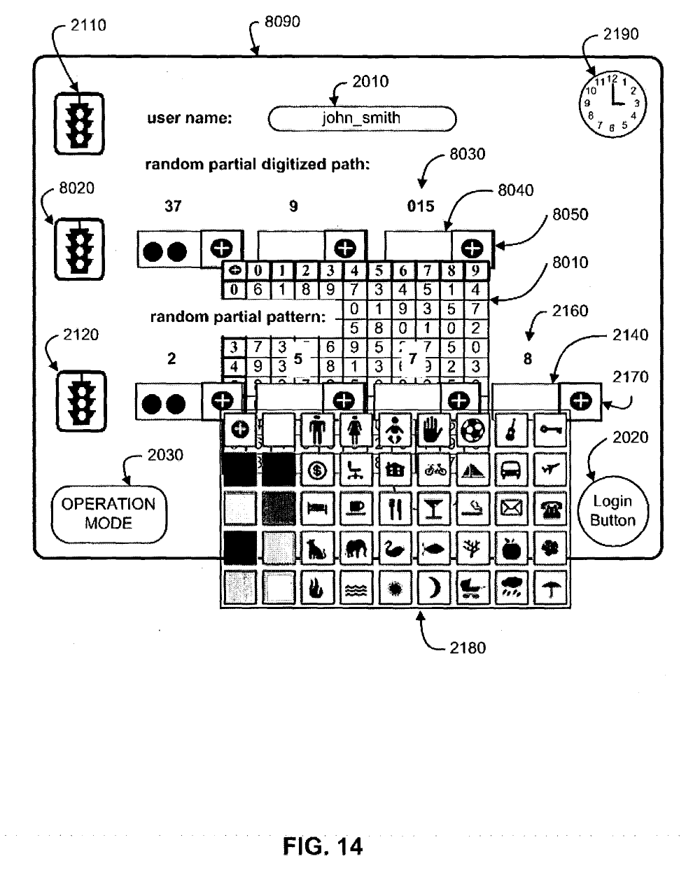

FIG. 14 illustrates a graphical user interface screen 8090, which is presented at the beginning of an authentication session using strong authentication based on a combination of RPPR and RPDPR after the user name in field 2010 is recognized by the server. Otherwise, if the user name is not accepted by the authentication server, “random partial digitized path” prompt and its respective objects, and the second stop light icon 8020 do not appear in screen 8090, while the first stop light icon 2110 will turn red signaling access denied (or user name is incorrect). Certainly, if the user name is not accepted by the authentication server “random partial pattern” prompt and its respective objects, and the third stop light icon 2120 do not appear in screen 8090 as well. The features of the graphical user interface for fulfillment of the RPPR and RPDPR authentication factors are given the same reference numerals as used in FIGS. 12 and 13, and are not described again.

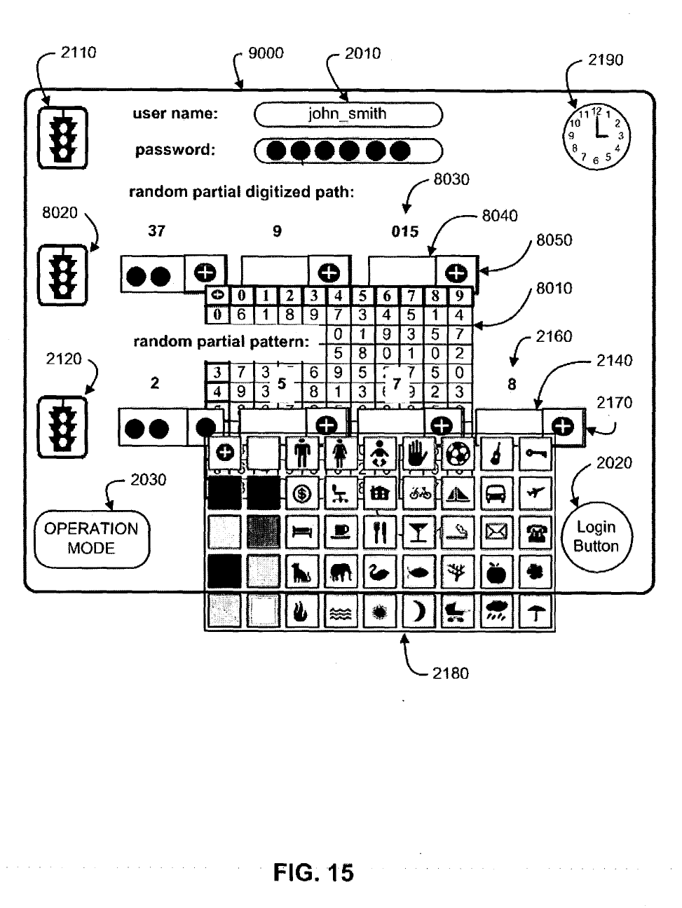

FIG. 15 illustrates a graphical user interface screen 9000, which is presented at the beginning of an authentication session using strong authentication based on a combination of SSPR, RPPR and RPDPR after the user name in field 2010 is recognized by the server. Otherwise, if the user name and/or a password are/is not accepted by the authentication server, “random partial digitized path” prompt and its respective objects, and the second stop light icon 8020 do not appear in screen 9000, while the first stop light icon 2110 will turn red signaling access denied (or user name and/or password are/is incorrect). Certainly, if the user name and/or a password are/is not accepted by the authentication server, “random partial pattern” prompt and its respective objects, and the third stop light icon 2120 do not appear in screen 9000 as well. The features of the graphical user interface for fulfillment of the SSPR, RPPR and RPDPR authentication factors are given the same reference numerals as used in FIGS. 12 and 13, and are not described again.

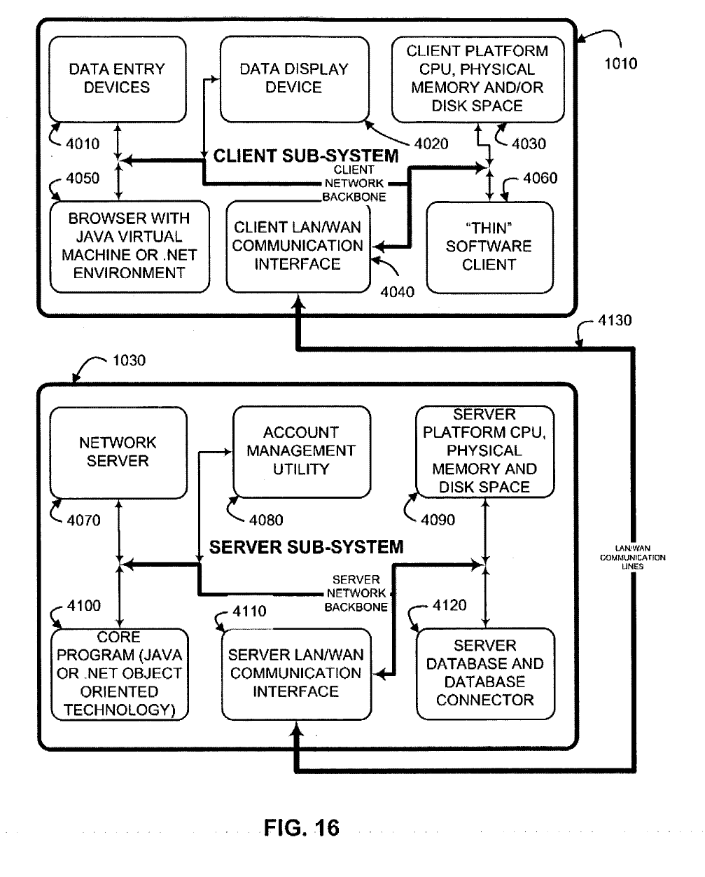

FIG. 16 illustrates a client/server system including authentication resources according to the RPDPR and RPPR authentication factors of the present invention. The client subsystem 1010 includes data entry devices 4010 (keyboard, mouse, voice input, etc.), a display device 4020 (CRT, LCD panel, etc.), and a physical platform 4030 (personal computer, hand held computer, internet appliance, etc.) including a processing unit, memory, and other data processing resources. Software running in the client includes a browser 4050 or a “thin” software client 4060 such as may be provided on personal digital assistants, cell phones, and other simple internet appliances which may not support full browser functionality. The browser 4050 includes Java Virtual Machine or a .NET environment which supports the client/server dialog. Likewise, the “thin” software client 4060 may support the client/server dialog. Finally, an interface 4040 to the network communication media 4130 is provided. The communication media 4130 may be a private or pubic, local area network or a wide area network using wired, wireless or optical media in representative systems.

The server subsystem 1030 includes network server resources 4070, an account management utility 4080 for the user accounts subject of the authentication process, and a platform 4090 including a processing unit, memory, disk space and other data processing resources. A core program 4100 supporting the authentication process is included in the server subsystem 1030. The core program may be implemented using Java or NET object-oriented technology for examples. Also, a server database and database connector 4120 is included. Finally, an interface 4110 to communication media for server LAN/WAN communication lines 4130 is provided. In some embodiments, the server and server data are implemented with security features to protect user account information files from intruders.

In various embodiments, the present system is used for user authentication in a client/server network architecture, for authentication of hardware devices (where the clients comprise peer routers for example) and in other environments supporting interactive authentication sessions. Interactive authentication based on combinations of the Random Partial Pattern Recognition (RPPR) algorithm, the Random Partial Digitized Path Recognition (RPDPR) algorithm and the Standard Static Password Recognition (SSPR) algorithm provides significant security protection against multiple known intruder attacks. The interactive, multi-field pattern process of the present invention, such as the RPPR and RPDPR establishes a new paradigm, replacing or enhancing standard static password technology. By capitalizing on modern high clock rate client/server CPU processing power and high network throughput, the strong authentication process, RPPR and RPDPR, are all easy to use.

In the examples described above, user authentication begins with a client's initial request to a protected network destination. Then, the server, having known the client's user name and the shared secret full pattern, prompts the client through the client's GUT to fulfill a subset of the user's full pattern randomly selected by the server. The full pattern is a pre-set shared secret between the client and the server established during the client account set-up. The full pattern resides in the database on the server side. Each field in the random subset requested from the client is associated with a displayed sequence number corresponding to a position in the full pattern. Each field in the GUI allows entering any combination of objects (at least one object per field is to be entered). In the example presented for RPPR, the objects entered in the field may be any number of alphanumeric characters, one image icon and one color background icon from a pop-down field menu fixed selection. In the example presented for RPDPR, the objects entered in the field may be selected from a randomized set of indicators on a representation of the reference grid, that are located at the coordinates stored in the subset of the data set storing the full digitized path. Upon receiving the client's response, the server compares internally computed expected combination with the client's input data, and makes a no/go authentication decision, provided the response is false/true.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims. What is claimed is:

1. An interactive method for authentication of a client, comprising:
first prompting the client to provide a first “what user knows” authentication factor, and verifying the first “what user knows” authentication factor; and
after verifying the first “what user knows” authentication factor, second prompting the client to provide a second “what user knows” authentication factor which is algorithmically and parametrically independent of the first “what user knows” authentication factor, and verifying the second “what user knows” authentication factor, wherein at least one of the first and second “what user knows” authentication factors is based on a random partial subset of a data set known to the client.

2. The method of claim 1, wherein at least one of said first and second prompting includes presenting to the client from a server via a data communication medium, a clue concerning said random partial subset.

3. The method of claim 1, wherein at least one of said first and second prompting includes presenting a graphical user interface to the client from a server via a data communication medium, the graphical user interface displaying a clue concerning said random partial subset.

4. The method of claim 1, wherein one of the first and second “what user knows” authentication factors comprises static password recognition.

5. The method of claim 1, wherein one of the first and second “what user knows” authentication factors comprises static password recognition, and the other of the first and second “what user knows” authentication factors based on said random partial subset comprises random partial pattern recognition.

6. The method of claim 1, wherein one of the first and second “what user knows” authentication factors comprises static password recognition, and the other of the first and second “what user knows” authentication factors based on said random partial subset comprises random partial digitized path recognition.

7. The method of claim 1, wherein one of the first and second “what user knows” authentication factors comprises random partial pattern recognition, and the other of the first and second “what user knows” authentication factors comprises random partial digitized path recognition.

8. The method of claim 1, wherein at least one of said first and second prompting includes presenting to the client from a server via a data communication medium, a clue concerning said random partial subset; and including
storing said data set in a memory, data fields in said data set having respective positions in said data set and respective field contents, the respective field contents for data fields in said data set include data known to the client based on a function of the respective positions in said data set, and wherein said clue comprises positions in said data set.

9. The method of claim 8, wherein at least one of said first and second prompting includes presenting to the client from a server via a data communication medium, a graphical user interface which displays the clue, and an input construct facilitating input by the client of data corresponding to said parameters.

10. The method of claim 1, wherein at least one of said first and second prompting includes presenting to the client via a data communication medium, a clue concerning said random partial subset; and including
storing said data set in a memory, data fields in said data set having respective positions in said data set and respective field contents, the respective field contents for data fields in said data set identifying coordinates along a digitized path known to the client on a reference grid, and wherein said clue comprises positions in said data set.

11. The method of claim 10, wherein at least one of said first and second prompting includes presenting to the client from a server via a data communication medium, a graphical user interface which displays the clue, and an input construct facilitating input of data corresponding to said positions by the client.

12. The method of claim 1, wherein at least one of said first and second prompting wherein at least one of said first and second prompting includes presenting to the client from a server via a data communication medium, a graphical user interface which displays the clue, and an input construct facilitating input of data corresponding to said positions by the client; and including
storing said data set in a memory, data fields in said data set having respective positions in said data set and respective field contents, the respective field contents for data fields in said data set identifying coordinates along a digitized path known to the client on a reference grid, and wherein said clue comprises positions in said data set;
wherein said input construct comprises a representation of said reference grid having a randomized array of indicators occupying locations in the reference grid, and input fields for inserting indicators from said randomized array of indicators corresponding to said random partial subset.

13. The method of claim 1, including:
detecting an attempt to access a protected network resource by the client, and wherein one of said first prompting and second prompting is responsive to detecting the attempt; and
after verifying said first and second “what user knows” authentication factors, signaling authentication of the client to the protected network resource.

14. The method of claim 1, including:
after verifying the second “what user knows” authentication factor, third prompting the client to provide a third authentication factor which is algorithmically and parametrically independent of the first and second “what user knows” authentication factors, and verifying the third authentication factor.

15. The method of claim 14, wherein one of the first, second and third authentication factors comprises random partial pattern recognition, another of the first, second and third authentication factors comprises random partial digitized path recognition, and yet another of the first, second and third authentication factors comprises static password recognition.

16. The method of claim 1, including:
displaying an icon during at least one of said first and second prompting and verifying, said icon having a first state during said prompting, a second state while waiting for verification, and a third state after verification.

17. The method of claim 1, including:
displaying a stop light icon during at least one of said first and second prompting and verifying, said icon displaying a red light during said prompting, displaying a yellow light while waiting for verification, and displaying a green light after verification.

18. An interactive method for authentication of a client, comprising:
storing a data set including data fields in a memory, data fields in said data set having respective positions in said data set and respective field contents, and storing information concerning a static password;
prompting the client to enter the static password;
accepting first input data from the client via a data communication medium, corresponding to the static password;
determining whether the first input data matches the static password;
identifying to the client via a data communication medium, positions in said data set of a random partial subset of data fields from said data set;
accepting second input data from the client via a data communication medium, corresponding to field contents of data fields in the random partial subset of said data set; and
determining whether the second input data matches the field contents of corresponding data fields in the random subset.

19. The method of claim 18, including if the first and second input data matches, signaling successful authentication, and if the first or the second input data does not match, signaling failed authentication.

20. The method of claim 18, wherein the respective field contents for data fields in said data set includes data known to the client based on a function of the respective positions in said data set.

21. The method of claim 18, wherein the respective field contents for data fields in said data set identify coordinates along a digitized path known to the client on a reference grid.

22. The method of claim 18, including
storing said data set in a memory, wherein the respective field contents for data fields in said data set identify coordinates along a digitized path known to the client on a reference grid;
wherein said identifying includes presenting graphical user interface to the client from a server via a data communication medium, the graphical user interface including a representation of positions of data fields in said data set of said random partial subset, a representation of said reference grid having an array of indicators locations at coordinates in the reference grid, and input fields for inserting indicators from said array of indicators from locations coordinates identified by field contents of data fields at the positions in said data set of said random partial subset.

23. The method of claim 18, including presenting to the client an input construct for account set up, and accepting data from the client based on the input construct, to set field contents for the data fields in the data set.

24. The method of claim 18, including presenting to the client an input construct for entry of data corresponding to field contents of said random partial subset, and wherein said accepting second input data from the client includes accepting data based on said input construct.

25. The method of claim 18, including providing a session timer, and including disabling a client session if an elapsed time exceeds a threshold before an event in an authentication session.

26. The method of claim 18, wherein said client provides input data in a client system coupled to communication media.

27. The method of claim 18, wherein said client provides input data in a client system, including a browser coupled to communication media.

28. The method of claim 18, including:
displaying an icon during said identifying, accepting and determining, said icon having a first state during said identifying positions in said data set, a second state after said accepting second input data and while waiting for said determining whether the second input data matches the random partial subset of said data set, and a third state if it is determined that the second input data matches the random partial subset of said data set.

29. The method of claim 18, including:
displaying a stop light icon during said identifying, accepting and determining, said icon displaying a red light during said identifying positions in said random partial subset, displaying a yellow light after said accepting second input data and while waiting for said determining whether the second input data matches the random partial subset of said data set, and displaying a green light if it is determined that the second input data matches the random partial subset of said data set if it is determined that the second input data matches the random partial subset of said data set.

30. The method of claim 18, including:
displaying an icon during said prompting, accepting and determining, said icon having a first state during said prompting, a second state after said accepting first input data and while waiting for said determining whether the first input data matches the static password, and a third state if it is determined that the first input data matches the static password.

31. The method of claim 18, including:
displaying a stop light icon during said prompting, accepting and determining, said icon displaying a red light during said prompting, displaying a yellow light after said accepting first input data and while waiting for said determining whether the first input data matches the static password, and displaying a green light if it is determined that the first input data matches the static password.

32. An authentication system for a client, comprising:
data processing resources, including a processor, memory and a communication interface;
user account information stored in said memory, including for respective clients information a first “what user knows” authentication factor and information concerning a second “what user knows” authentication factor, where the information concerning one of the first and second “what user knows” authentication factors comprises a data set including a data set of data fields, data fields in said data set having respective positions in said data set and respective field contents;
an authentication server adapted for execution by the data processing resources, including logic to prompt the client via the communication interface to provide the first “what user knows” authentication factor, logic to identify to the client via the communication interface, positions in said data set of a random partial subset of data fields from said data set; logic to accept input data from the client via the communication interface corresponding to said first “what user knows” authentication factor and corresponding to field contents for corresponding data fields in the random partial subset; and logic to determine whether the input data matches said first “what user knows” authentication factor and said field contents of corresponding data fields in the random partial subset.

33. The system of claim 32, wherein the authentication server includes logic which if the input data matches, signals successful authentication, and if the input data does not match, signals failed authentication.

34. The system of claim 32, wherein the respective field contents for data fields in the data set include data based on a function known to the client of the respective positions of corresponding data fields in said data set.

35. The system of claim 32, wherein the respective field contents for data fields in the data set include coordinates along a digitized path known to the client on a reference grid.

36. The system of claim 32, including logic to present to the client a graphical input construct for entry of data corresponding to field contents of said random partial subset.

37. The system of claim 32, wherein the respective field contents for data fields in said data set identify coordinates along a digitized path known to the client on a reference grid;
wherein said logic to identify includes a graphical user interface for presentation to the client, the graphical user interface including a representation of positions of data fields in said data set of said random partial subset, a representation of said reference grid having an array of indicators locations at coordinates in the reference grid, and input fields for inserting indicators from said array of indicators from coordinates identified by field contents of data fields at the positions in said data set of said random partial subset.

38. The system of claim 32, including logic to provide a session timer, and logic to disable a client session if an elapsed time exceeds a threshold before an event in an authentication session.

39. The system of claim 32, wherein said authentication server includes:
logic to display an icon to the client, said icon having a first state while said logic identifies positions of said random partial subset, a second state after said logic accepts input data and waits for said logic to determine whether the input data matches the random partial subset of said data set, and a third state if it is determined that the input data matches the random partial subset of said data set.

40. The system of claim 32, including:
logic to display a stop light icon to the client, said icon displaying a red light while said logic identifies positions of said random partial subset, displaying a yellow light after said logic accepts input data and waits for said logic to determine whether the input data matches the random partial subset of said data set, and displaying a green light if it is determined that the input data matches the random partial subset of said data set.

41. The system of claim 32, including:
logic to display a stop light icon displaying red, yellow and green light conditions to the client indicating progress of an authentication session.
